(19) United States
(12) Patent Application Publication
(10) Pub. No.: US 2016/0011758 A1
(43) Pub. Date: Jan. 14, 2016

(54) SYSTEM, APPARATUSES AND METHODS FOR A VIDEO COMMUNICATIONS NETWORK

(71) Applicant: Selfie Inc., New York, NY (US)

(72) Inventors: Hugh Dornbush, Brooklyn, NY (US); Thomas Clute Meggs, New York, NY (US)

(21) Appl. No.: 14/794,587

(22) Filed: Jul. 8, 2015

Related U.S. Application Data
(60) Provisional application No. 62/022,302, filed on Jul. 9, 2014.

(51) Int. Cl. G06F 3/0484; H04N 7/14; H04L 29/06; G06F 3/0488; H04N 5/77; H04N 7/15; G06F 3/0482

(52) U.S. Cl. CPC G06F 3/04847; H04N 7/15; H04N 7/142; G06F 3/0482; G06F 3/04842; G06F 3/04883; H04N 5/77; H04L 65/601; H04L 65/403

(57) ABSTRACT

An interactive social media network is disclosed to provide asynchronous face-to-face conversations via video selfies. The selfies are recording using a user interface that fosters engagement with the viewer by limiting the distractions of recording. The conversations are structured into a user interface that allows navigation of conversational threads that enable numerous diverse individuals to be involved in the same conversation. The disclosure further provides an efficient mechanism to upload and distribute the selfie videos.

### RELATED APPLICATIONS

The present invention claims all rights of priority to Provisional Application No. 62/022,302, filed on Jul. 9, 2014, which is hereby incorporated by reference.

### FIELD OF THE INVENTION

The present disclosure is directed to systems and methods for on-line communications, and, in particular, advantageous user interfaces, system architectures and networking platforms for the same.

### BACKGROUND OF THE INVENTION

Online social networks are a now a ubiquitous feature of modern life. Increasingly, social networks such as Facebook, Twitter, and LinkedIn provide virtual platforms for facilitating interactions among Internet users. Social networking services may be used to maintain existing relationships, build new relationships based on shared interests, activities, goals, or background, and often facilitate the creation of an online persona for users.

However, the currently available social networking services suffer from a number of drawbacks. Text-based interactions often lack emotional impact and feel inauthentic or insincere. As a result, text based communications tend to restrict one's ability to empathize with the speaker. Meanwhile, short-form video sharing services such as Vine and Snapchat provide a platform for sharing videos but lack a user-interface and social networking features that foster dialog.

### Overview of the Disclosed System

The present disclosure describes a social networking platform that enables users to hold virtual one-on-one asynchronous conversations with an unlimited number of people by sharing and responding to short videos. The user interface for these asynchronous conversations advantageously provides one-on-one personal interactions in an asynchronous platform that does not require the parties involved to be interacting at the same time. In this way, the online interaction mimics the natural flow of an offline conversation but preserves the advantages of traditional social media exchanges. Applicants disclose herein a social video messaging application utilizing a client-server architectural model. The video service enables a many-to-many conversation where anyone using the system can interact with anyone else through the exchange of short videos, preferably shot through the front-facing camera of a smartphone and uploaded over mobile data networks or Wi-Fi to the systems cloud-based server system.

The videos exchanged through the system preferably show a user, who may or may not be discussing some topic. The videos that are the subject of the systems disclosed herein are referred to as “Selfies.” Any user may reply to any Selfie with another Selfie to facilitate communications. Selfies and their replies are automatically linked together into “Conversations”, with visibility of replies determined through Selfie's custom ranking algorithm based upon user popularity as determined through user feedback.

The system architecture is service based, redundant, and scalable. Clients use a method of address discovery when first launching to determine the most appropriate API host to contact.

Inbound requests are first received by an SSL Terminator that notes the client's origination IP, which is passed to a Load Balancer. The Load Balancer then passes this request to one API instance out of a cluster of available API instances. The instance the request is sent to is chosen based on the health of the available instances. The health determination is based on criteria, such as, response time and capacity. When processing requests, the API instances may use a high performance cache to speed operations and offset the load to the database. If the API is unable to receive applicable data from cache, it will contact a database adapter that in turn sends requests into a database cluster. The database cluster (e.g. Mongo, Postgres, Neo4j, Elasticsearch, et cetera) provides responses to the API comprising data pertaining to the client's request. The database fulfills data requests pertaining to a variety of information, such as likes, replies, friend lists, follow information, details on posts, ordering of replies, or any other detail that drives our system and user interactions.

The primary client for the service is a mobile app for use on users' smartphones and the client in the present disclosure will be described in the context of a smartphone application (or app) and more specifically an iPhone app. A person of skill in the art, however, would readily recognize that the client disclosed herein could readily be implemented on a variety of other devices, including other smartphone architectures (e.g., Android, Windows Phone, Blackberry, Symbian), tablets, laptop or desktop computers, videogame systems (handheld or console), TV set top boxes, smart TVs, PDA's, etc.

The Selfie client utilizes a number of strategies to increase performance and data availability via a caching layer when making requests for media and via a data abstraction layer when making calls to our API. It attempts to predictively gather data in advance of what a user may be interested in requesting to provide for the most seamless experience possible.

In a preferred embodiment, users record up-to-24 seconds of video, shot through the front-facing camera of their phone. Other video lengths, however, can be employed. To assist users, the client app provides a recording process specifically designed for shooting Selfies. For instance, the client app provides a Restart button that enables users to easily do multiple “takes” of their Selfie video because users are often dissatisfied with their first attempt. The client app further provides a “Distractions Off” mode that minimizes or eliminates on-screen visual feedback while recording. This mode provides more optimal conditions for a user to feel at ease while recording because for example they are not distracted.

The client app enables a user to specify a single still frame of video, which is saved independently to the system as a photo, through a custom cover-picker interface. This photo serves as the “Cover” of the Selfie. A user may further optionally append a text caption to each Selfie, preferably up to 120 characters. This short caption facilitates standard social media and Internet conventions such as @mentions, #hashtags and URLs. Certain metadata can further be appended to each Selfie, including the poster's username, the location of the Selfie and the time since the Selfie was uploaded. Once the video, cover and metadata are successfully uploaded from the posting user's mobile app, the Selfie is available for other user's consumption.

Every user interacts with other users' content through vertically-scrollable feeds of Selfies, which is provided by the client application. The default view is the “Home” feed, displaying the content posted by other users that the consuming user has chosen to “Follow.” A user may follow (or unfollow) another user at any time to add (or remove) another user's Selfies from this feed. Other examples of vertical feeds provided by the client application include “Me” (the user's profile, displaying all the Selfies he or she has posted), “Search Results” (displaying all Selfies that match a user-entered search criteria), “Profile” (displaying all Selfies another user has posted), “Liked” (displaying all Selfies a user has liked) and “Location” (displaying all Selfies posted by other users in a particular city (or a particular venue within that city.)

Each feed of Selfies preferably displays one Selfie at a time, stacked vertically and preferably ordered by time posted. In feeds, metadata is superimposed upon each Selfie's cover. Below the cover are Like, Reply and Conversation buttons and the user-submitted caption. A user may press the Like button to make a positive public gesture about any other Selfie or the Reply button to reply to a Selfie with another Selfie. Counts of both Likes and Replies associated with a specific Selfie are displayed.

A user may open the Conversation by pressing the diamond-shaped “Conversation” button, preferably located below the cover and between the Like and Reply buttons. The top part of the Conversation button overlaps the bottom of a Selfie. The Conversation button matches the direction and color of the glowing navigation arrows to display the up-to-four directions a user can slide to navigate. Upon opening a Conversation, the currently viewed Selfie shrinks in size, while maintaining its proportion, to provide the user a birds-eye view of that particular Selfie in the context of its place within a wider conversation. A conversation preferably shows a single central band of Selfie covers linked horizontally. The conversation further preferably displays in a vertical band up to two stacks of replies to any particular Selfie currently displayed in the horizontal band. In Conversation view, a user may scroll horizontally to go forward or back in a Conversation of Selfies, browsing through generations of Selfies organized in a parent-children relationship. Since any Selfie may have an unlimited number of replies, a user may scroll vertically to browse all replies to a Selfie, with the top replies (preferably, determined by user feedback) found at the top of a stack of replies. Below the Conversation button, a count of how many people are participating in the conversation is displayed. Upon tapping a Selfie cover, the cover expands to feed view and video playback begins.

As an alternate method of navigating between videos in a Conversation of Selfies, a user may employ Slide Navigation, a custom navigation concept and implementation to allow easy navigation through a complex Conversation where any Selfie may have an unlimited number of replies. Upon touching a playing Selfie, video playback pauses, the current frame of video blurs (to remove the user's focus from the content), and up to four glowing arrows (left, right, up, down) are displayed so a user may navigate back and forward in a Conversation or up and down through stacks of replies by actuating the arrow user interface elements or swiping in the desired direction. The color and placement of these glowing arrows are consistent with those of the four navigation arrows that comprise the Conversation user interface element below the Selfie. Upon swiping in any of the four permitted directions, a user may Slide Navigate, described below, from one Selfie to another within a Conversation.

In one embodiment of the disclosed method, a computer-implemented method for presenting and interacting with a computing device having a screen provides an asynchronous video conversation thread. The method comprises displaying a first video on the screen of the computer device, wherein the video comprises a portion of a conversation in reply to an earlier video, and wherein the computer device is configured to accept user input. Subsequently, the computing device receives user input representing a directional movement vertically or horizontally. Next, the computing device displays a second video in the conversation that is a reply to the first video when the accepted user input is a horizontal directional movement in a first direction. The computing device may also display the earlier video when the accepted user input is a horizontal directional movement in a second direction or display a third video that is a reply to the earlier video when the accepted user input is a vertical directional movement.

In another embodiment, the user input may be provided via a touch interface, wherein the first direction is either left or right and wherein the user input includes a four way directional input graphical interface element. The horizontal directional movement and the vertical directional movement may be accomplished with a swipe gesture. Further, two or more videos may be arranged vertically around the first video and may be accessed via the vertical directional movement. The order of the two or more videos is determined based on a weight computed using one or more of the following criteria: likes, plays, replies, or mentions. The user interface may include an element to initiate a reply to the first video and another element to initiate a like of the first video.

In another embodiment of the disclosed method, a computer-implemented method presents a user interface for video recording on a device comprising a display screen and a front facing camera providing a video feed to the device and a user input apparatus. The method comprises displaying a live view of the video feed from the front facing camera on the display screen, receiving via a record command via the user input apparatus, initiating recording in response to the record command, and obscuring the display of the live view of the video feed from the front facing camera in response to the record command and continuing to obscure the display while recording is ongoing.

In this embodiment, the method may include a user interface element to toggle the obscuring feature on and off, wherein the obscuring may be accomplished by, inter alia, blurring the live view of the video feed, turning off the screen, or replacing the video screen with a graphic. The user interface may also display a message on the display screen directing a user to look at the camera in response to the record command.

In a further embodiment of the disclosed system, a system presents and allows the user to interact with an asynchronous video conversation chain. The system comprises a computing device having a touch screen, a processor and a memory and computer code stored in the memory. The computer code is configured to display a first video on the screen of the computer device, wherein the video comprises a portion of a conversation in reply to an earlier video, and wherein the computer device is configured to accept user input; receive user input via the touch screen representing a directional movement vertically or horizontally; display a second video in the conversation that is a reply to the first video when the accepted user input is a horizontal directional movement in a first direction; display the earlier video when the accepted user input is a horizontal directional movement in a second direction; and display a third video that is a reply to the earlier video when the accepted user input is a vertical directional movement.

In a further embodiment of the disclosed method, a computer-implemented method for presenting and interacting with a computing device having a touch screen provides an interface for selecting a color. The method comprises displaying a first set of color blocks arranged in a horizontal band across the screen of the computing device; receiving user input via the touch screen representing a horizontal directional movement, and in response displaying a second set of color blocks in the horizontal band across the screen of the computing device; receiving user input via the touch screen representing a tap on the desired color block, and in response displaying a first set of detailed shades of the selected color in vertical bands on the screen of the computing device; receiving user input representing a vertical directional movement along the bands of detailed shades of the selected color, and in response displaying a second set of detailed shades of the selected color in vertical bands on the screen of the computing device, wherein the second set of detailed shades of the selected basic color comprises a lighter or darker set of shades contiguous to the first set of shades; and receiving user input via the touch screen representing a tap on the desired shade of the selected color.

The first set of colors may comprise a portion of all available colors, while the second set of colors may comprise a different portion of all available colors. Similarly, the first set of detailed shades may comprise a portion of all possible shades of a given color, and the second set of detailed shades may comprise a different portion of all possible shades of the said given color.

In a further embodiment, a computer-implemented method using a computer server system uploads a video as part of an asynchronous video conversation chain. The method comprises receiving video stream data from a client computing device immediately after said client computing device begins recording a video; receiving and processing a static image from a frame of the recorded video once the full video stream data has been received; receiving metadata associated with the recorded video; and making the video available for display to other users by linking the associated metadata and the processed static image to the received video stream. The associated metadata includes one or more of the following: the location where the video was recorded, a caption describing the video, people involved in the video, venue information, recording time, and access controls. Receiving the static image may also be accomplished by receiving a time stamp identifying the location of the static image in the video stream. In accordance with the access controls received in the associated metadata, the computer server may also limit access to the recorded video.

### BRIEF DESCRIPTION OF THE FIGURES

FIG. 1 shows a currently preferred embodiment of the Selfie app icon, displayed on a user's iPhone home screen.

FIG. 2 shows a currently preferred embodiment of the logged out screen on Selfie's iPhone client.

FIG. 3 shows a currently preferred embodiment of a Selfie in a user's feed.

FIG. 4 shows more detail about a currently preferred embodiment of a Selfie in a user's feed.

FIG. 5 shows a currently preferred embodiment of the Paused state and Conversation buttons on Selfie's iPhone client.

FIG. 6 shows a currently preferred embodiment of Slide Navigation in a user's feed.

FIG. 7 shows a currently preferred embodiment of a list of Likes associated with a particular Selfie.

FIG. 8 shows a currently preferred embodiment of a list of Replies associated with a particular Selfie.

FIG. 9 shows a currently preferred embodiment of a Conversation of Selfies.

FIG. 10 shows a currently preferred embodiment of a Conversation of Selfies.

FIG. 11 details a currently preferred embodiment of a user interaction within a Conversation of Selfies.

FIG. 12 details a currently preferred embodiment of a user interaction within a Conversation of Selfies.

FIG. 13 details a currently preferred embodiment of a user interaction within a Conversation of Selfies.

FIG. 14 details a currently preferred embodiment of a user interaction within a Conversation of Selfies.

FIG. 15 details a currently preferred embodiment of a user interaction within a Conversation of Selfies.

FIG. 16 details a currently preferred embodiment of a user interaction within a Conversation of Selfies.

FIG. 17 details a currently preferred embodiment of a user interaction within a Conversation of Selfies.

FIG. 18 shows a currently preferred embodiment of Selfie playback in a user's feed on Selfie's iPhone client.

FIG. 19 shows a currently preferred embodiment of Selfie playback in a user's feed on Selfie's iPhone client.

FIG. 20 shows a currently preferred embodiment of the Paused state and Slide Navigation in a user's feed on Selfie's iPhone client.

FIG. 21 shows a currently preferred embodiment of Slide Navigation in a user's feed on Selfie's iPhone client.

FIG. 22 shows a currently preferred embodiment of Slide Navigation in a user's feed on Selfie's iPhone client.

FIG. 23 shows a currently preferred embodiment of Slide Navigation in a user's feed on Selfie's iPhone client.

FIG. 24 shows a currently preferred embodiment of Slide Navigation in a user's feed on Selfie's iPhone client.

FIG. 25 shows a currently preferred embodiment of the Selfie recording process, before recording has been initiated.

FIG. 26 shows a currently preferred embodiment of the Selfie recording process, upon pressing the Record button.

FIG. 27 shows a currently preferred embodiment of the Selfie recording process, once recording has begun.

FIG. 28 shows a currently preferred embodiment of the Selfie recording process in Distractions Off mode.

FIG. 29 shows a currently preferred embodiment of a user interaction of sliding-to-navigate between steps of the Selfie recording process.

FIG. 30 shows a currently preferred embodiment of the Review step in the Selfie recording process, where a user may review his or her recently recorded Selfie.

FIG. 31 shows a currently preferred embodiment of the Review step in the Selfie recording process, where a user may select a preferred Cover for his or her recently recorded Selfie.

FIG. 32 shows a currently preferred embodiment of the Review step in the Selfie recording process, where a user may select a preferred Cover for his or her recently recorded Selfie.

FIG. 33 shows a currently preferred embodiment of a user interaction of sliding-to-navigate between steps of the Selfie recording process.

FIG. 34 shows a currently preferred embodiment of the Add Details step in the Selfie recording process.

FIG. 35 shows a currently preferred embodiment of an @Mention helper within the Add Details step in the Selfie recording process.

FIG. 36 shows a currently preferred embodiment of an @Mention helper within the Add Details step in the Selfie recording process.

FIG. 37 shows a currently preferred embodiment of list to specify a user's location within the Add Details step in the Selfie recording process.

FIG. 39 shows a currently preferred embodiment of list to specify a user's location within the Add Details step in the Selfie recording process.

FIG. 40 shows a currently preferred embodiment of a list to specify a user's location within the Add Details step in the Selfie recording process.

FIG. 41 shows a currently preferred embodiment of a user's Profile on Selfie's iPhone client.

FIG. 42 shows a currently preferred embodiment of a list of users a particular user is following on Selfie's iPhone client.

FIG. 43 shows a currently preferred embodiment of a user's own Profile, also called “Me,” on Selfie's iPhone client.

FIG. 44 shows a currently preferred embodiment of a user's Settings on Selfie's iPhone client.

FIG. 45 shows a currently preferred embodiment of Account Settings within a user's Settings on Selfie's iPhone client.

FIG. 46 shows a currently preferred embodiment of a Color Picker on Selfie's iPhone client.

FIG. 47 shows a currently preferred embodiment of Push Notification Settings on Selfie's iPhone client.

FIG. 48 shows a currently preferred embodiment of Password Settings on Selfie's iPhone client.

FIG. 49 shows a currently preferred embodiment of a Main Menu on Selfie's iPhone client.

FIG. 50 shows a currently preferred embodiment of a Notifications screen on Selfie's iPhone client.

FIG. 51 shows a currently preferred embodiment of an Explore area on Selfie's iPhone client.

FIG. 52 shows a currently preferred embodiment of an Explore area on Selfie's iPhone client, highlighting a subsection to explore hashtags.

FIG. 53 shows a currently preferred embodiment of a feed of results for a specific hashtag on Selfie's iPhone client.

FIG. 54 shows a currently preferred embodiment of an Explore area on Selfie's iPhone client, highlighting a subsection to explore People.

FIG. 55 shows a currently preferred embodiment of an Explore area on Selfie's iPhone client, highlighting a subsection to explore Places.

FIG. 56 shows a currently preferred embodiment of an Explore area on Selfie's iPhone client, highlighting a subsection to explore Places.

FIG. 57 shows a currently preferred embodiment of Selfie's web client.

FIG. 58 shows a currently preferred process when a client requests media required to view Selfies.

FIG. 59 shows a currently preferred process for a client to send Selfie data to the API.

FIG. 60 shows a currently preferred process for the API receipt of Selfie data from a client.

FIG. 61 shows a currently preferred process for the API handling of media content after receipt from a client.

FIG. 62 shows a currently preferred process for the API handling of user registration and authentication.

FIG. 63 shows a currently preferred process for feed generation when a user creates a new post.

FIG. 64 shows a currently preferred process for generating a conversation.

FIG. 65 shows a currently preferred process for ordering the collection of replies to a single Selfie according to the numerical “weight” metadata assigned to any given Selfie.

FIG. 66 shows a currently preferred embodiment of media traversing the server backend.

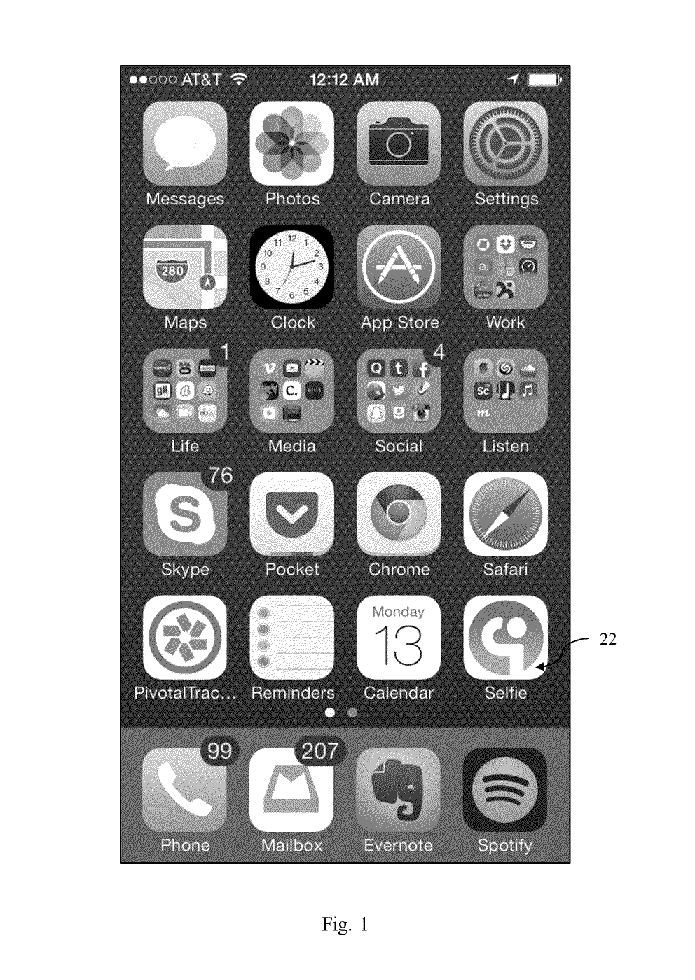

### DETAILED DESCRIPTION

The details of the disclosed systems, apparatuses and methods will now be described with reference to a currently preferred embodiment of the client application for the system. Running the client application, for example on an iPhone, integrates the device's camera, communications hardware, user input system and display into a unique apparatus for the exchange of video conversations.

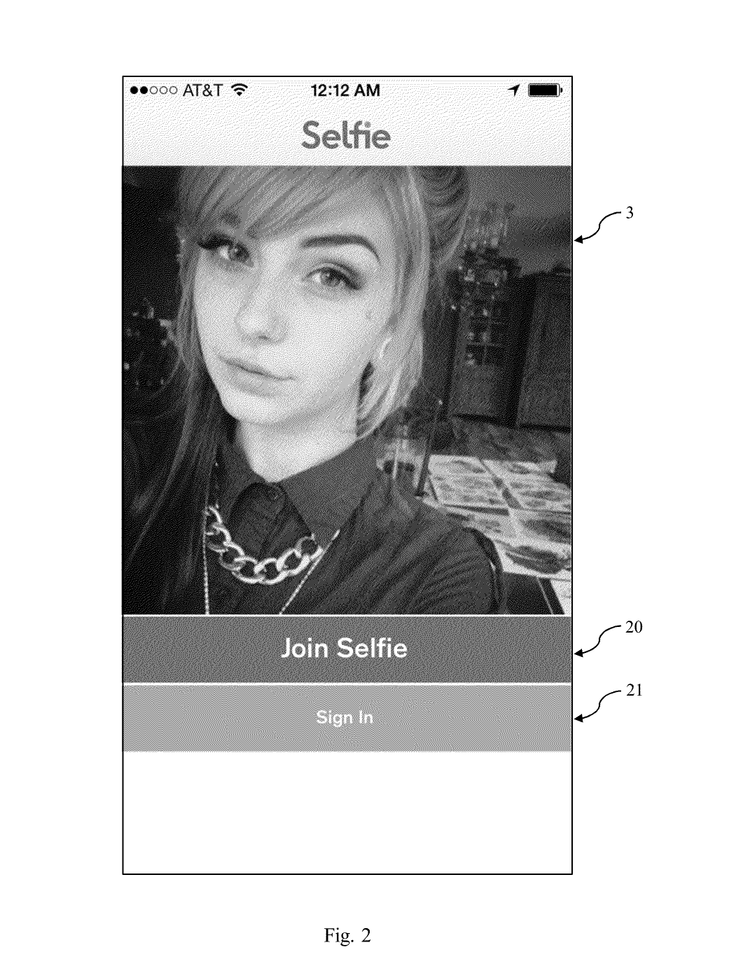

FIG. 2 shows the Logged Out Screen on the Selfie application for iPhone. The user may tap a Welcome Selfie to play a video Welcome Message (UI Element 3). Across the bottom of the screen are two buttons labeled “Join Selfie” (UI Element 20) and “Sign In” (UI Element 21). Tapping these buttons allows the user to create an account or access an existing account, respectively.

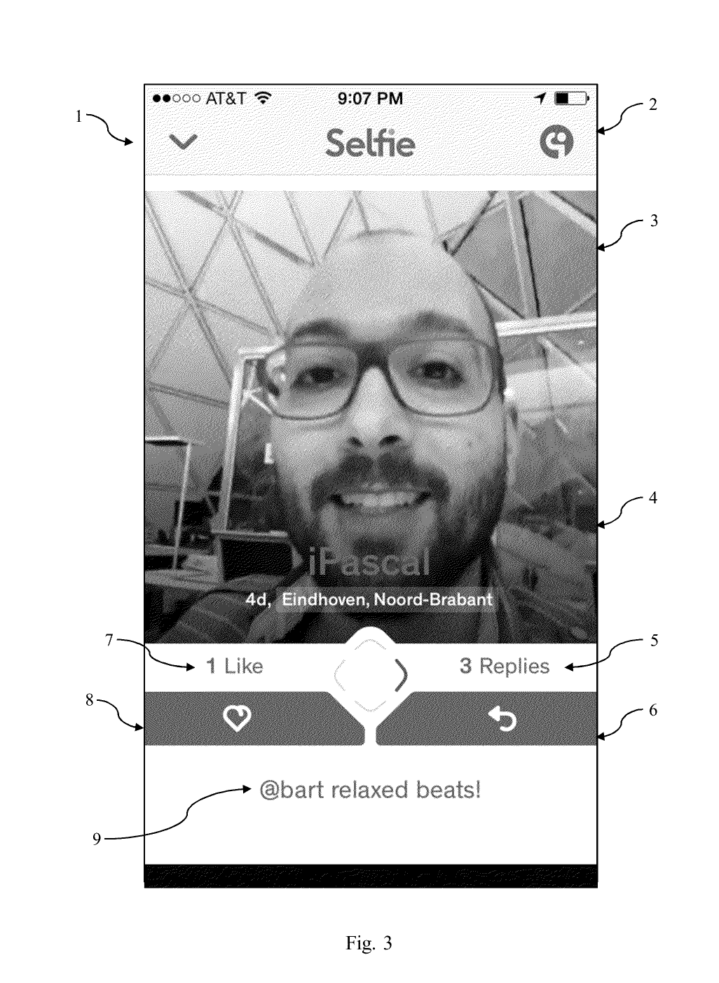

FIG. 3 shows the Selfie Feed user interface. Across the top of the screen is a navigation bar that allows the user quick access to certain features. There is UI Element 1, a downward-facing arrow allowing quick access to the Main Menu options, including “Home,” “Me,” “Notifications,” and “Explore”. There is UI Element 2, a circle with an illustrated depiction of a person shooting a Selfie, which is the “Shoot a Selfie” button, allowing the user entry into to the process for shooting and posting a Selfie.

Below the navigation bar is a vertically scrollable feed of Selfies, each possessing several standard characteristics, described below.

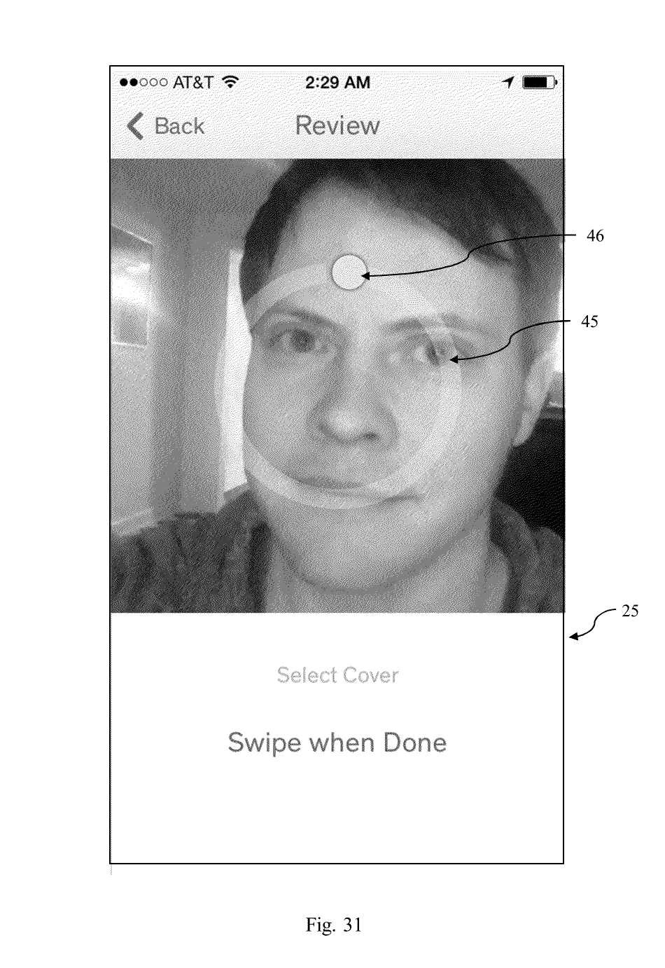

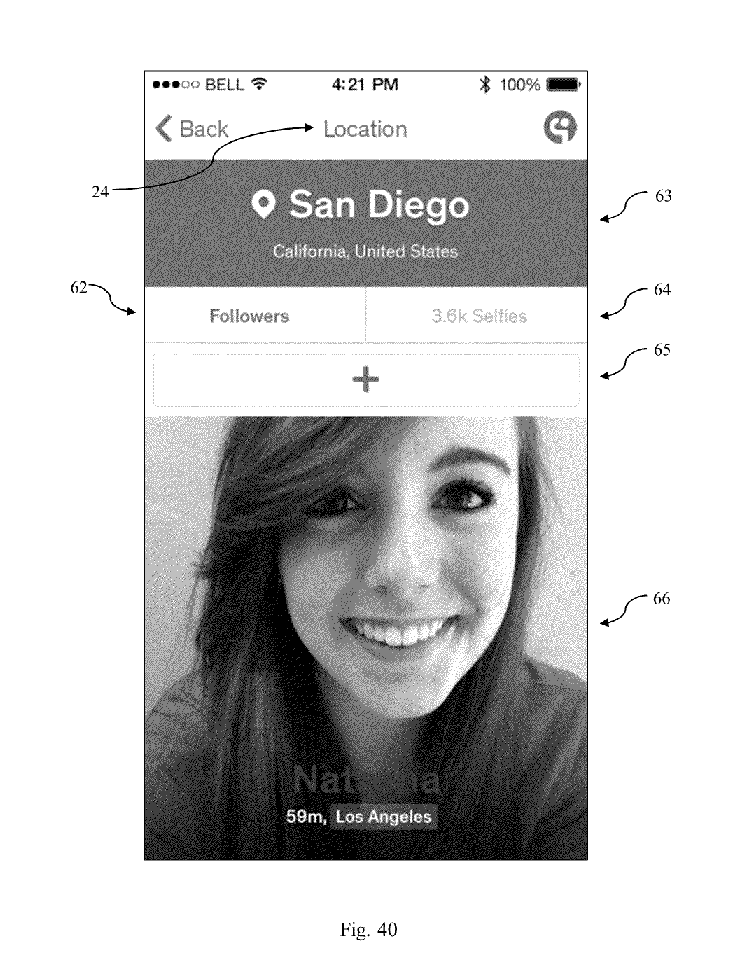

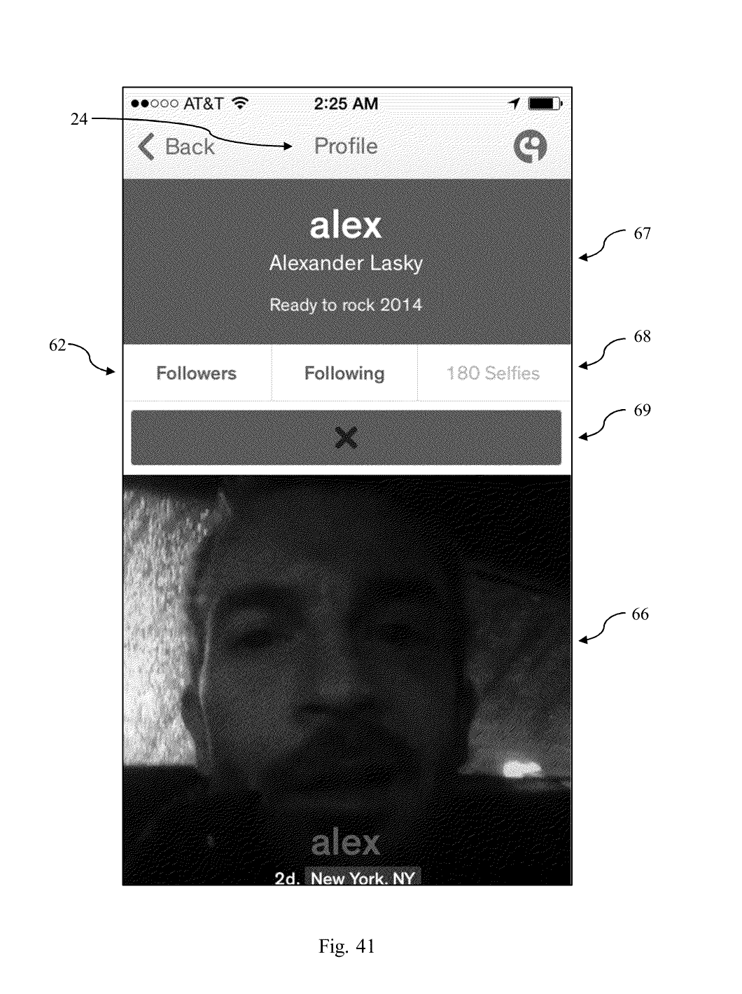

UI Element 3, the Selfie's “cover,” is a single static frame of an up-to-24 second Selfie video, selected by the uploading user during the recording process (FIG. 31) to serve as the static cover for this Selfie. Upon tapping a cover, the Selfie video begins playback as the person pictured comes to life through video. Superimposed on any Selfie is UI Element 4, metadata about the Selfie, including the poster's username, displayed in his or her chosen color, a timestamp indicating time since the Selfie was posted and the location where the Selfie was posted, which may be either a city or a specific venue within that city. Tapping the poster's Username will navigate to that user's profile (FIG. 41). Tapping the Location (Eindhoven . . . ) will navigate to that location or venue's profile (FIG. 40).

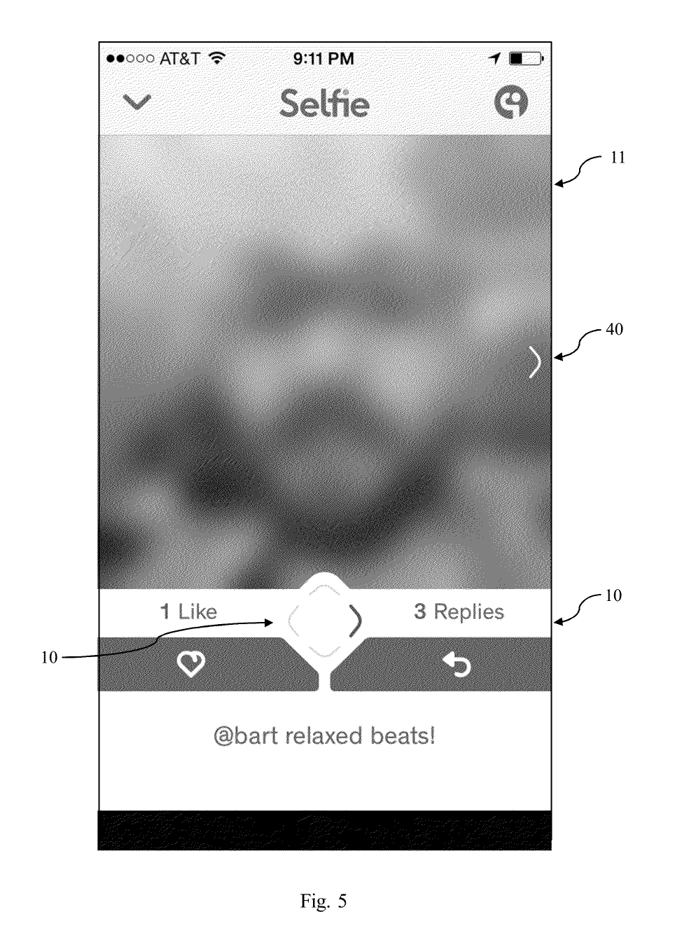

Below the cover are buttons for the consuming user to interact with this Selfie, including the Conversation button (FIG. 5, UI Element 10). To the left of the Conversation button is the Like button, UI Element 8, a 5-sided button in the consuming user's Selfie color displaying a heart glyph. Clicking the Like button adds a Like to the count of users who have liked this Selfie, UI Element 7, and the posting user receives an immediate notification that another user has liked his or her Selfie. To the right of the Conversation button is the Reply button, UI Element 6, a 5-sided button in the consuming user's Selfie color displaying a reply glyph. By default, the Like and Reply buttons are the posting user's chosen color. Clicking the Reply button allows the user entry into the process for shooting and posting a Selfie reply to this particular Selfie. The count of Replies, UI Element 5, communicates how many Replies to this Selfie have been posted.

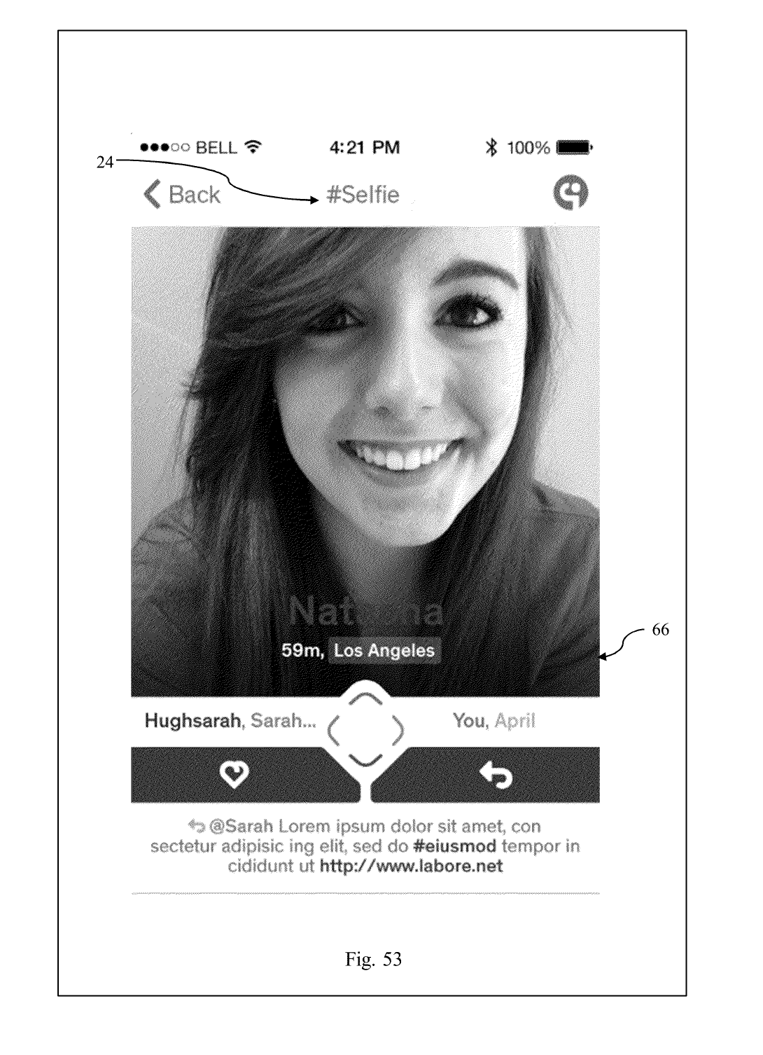

Below the buttons is a short text caption of preferably up-to 120 characters, UI Element 9. This caption displays a reply glyph, which shows if the Selfie is a reply to another Selfie. If a user's Selfie username is preceded by the @ symbol in the caption, a common social media convention commonly known as an “@Mention”, that text is clickable and navigates to the specified user's Selfie profile (FIG. 41). If a text string is preceded by the # symbol, that text is clickable as a hashtag and navigates to search results for the queried hashtag in the Explore screen (FIG. 53). If Selfie identifies a text string in the caption as a URL, that hyperlink will open the requested website.

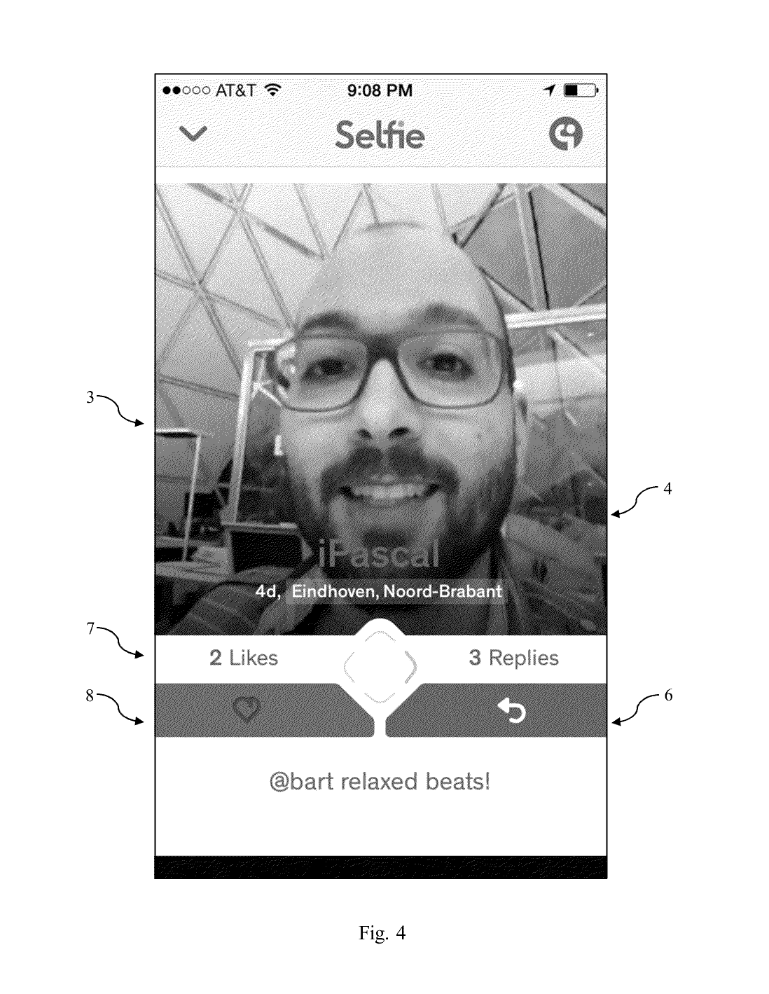

FIG. 4 provides additional detail about a Selfie. When tapping the Like or Reply buttons, users change the color of an engaged button from the original posting user's color (blue) to the clicking, or consuming user's color (green) (UI Element 8). Before a Selfie is engaged, the user may scroll vertically to browse a Feed of Selfies posted by other users that he or she is following (UI Element 3). Clicking the username displayed in the user's chosen color navigates to that user's profile, while tapping the Location navigates to that location's profile (UI Element 4). By default, the Like and Reply buttons are shown in the posting user's chosen color (UI Element 6). Liking a Selfie adds a Like to the count (UI Element 7). If the user taps the Like button, that color of the Like button changes to match the tapping user's color (UI Element 8).

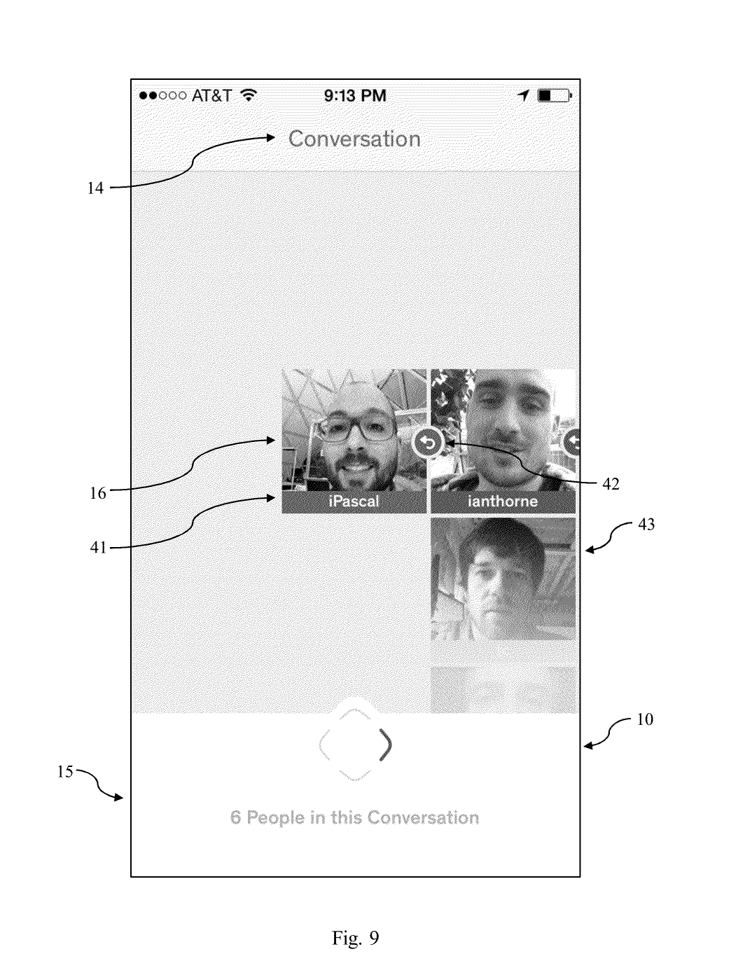

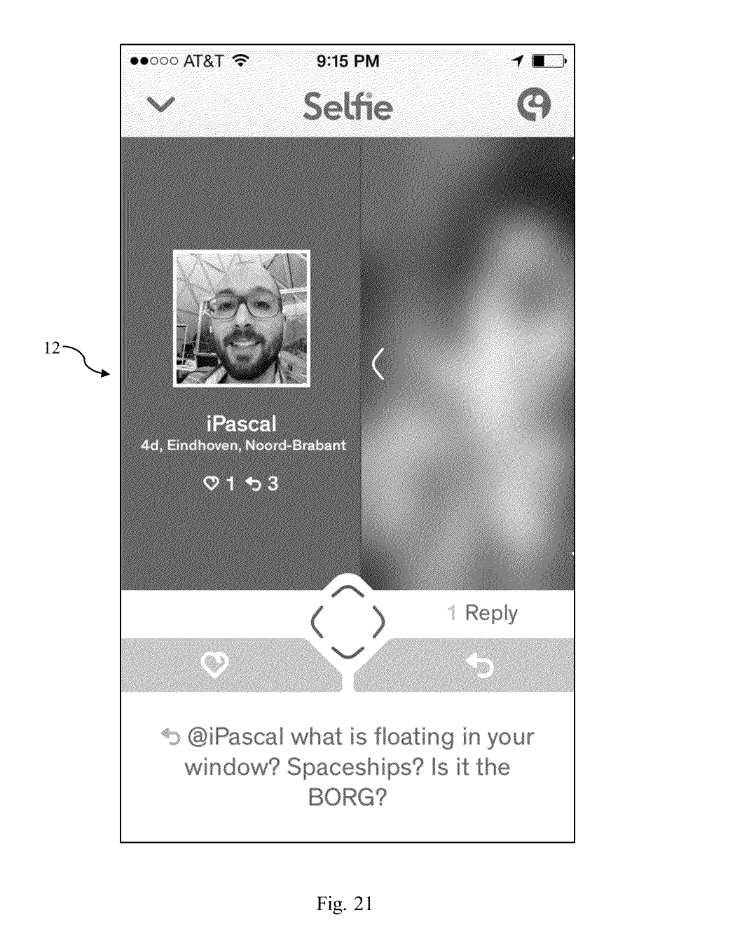

FIG. 5 provides additional detail about a Selfie, such as UI Element 10, the Conversation button. A user opens a Conversation by clicking a diamond-shaped “Conversation” button situated between the Like and Reply buttons. A Conversation button, by default, displays 4 grey arrows pointing up, down, left and right in a diamond-like layout commonly found in a directional-pad. Tapping the Conversation button results in an animation that reorients the user's perspective, appearing to zoom out to a bird's-eye view to see the current Selfie in its conversational context (FIG. 9). This is called “opening a Conversation.” If other Selfies are adjacent to this Selfie, a user may slide to navigate between Selfies to browse a Conversation. This is called “slide navigation.” (FIGS. 21-24) The Conversation button displays the up-to-four available directions a user might slide to navigate. Arrows are displayed in the appropriate color of the user to which they would be slide navigating. (In this case, to the right and “blue”).

UI Element 11 shows a paused Selfie. Touching a playing Selfie pauses the Selfie, ceasing playback immediately and blurring the current frame of video. Upon pausing a Selfie, glowing navigation arrows appear (UI Element 40), indicating where a user may next slide navigate. Glowing navigation arrows are displayed in the chosen color of the user to which they would be navigating. The color and orientation of these arrows corresponds to directional information conveyed by the Conversation button below the Selfie playback area. A user may touch and slide a playing or paused Selfie in up to four directions to navigate up, down, left, or right to adjacent Selfies in the same Conversation.

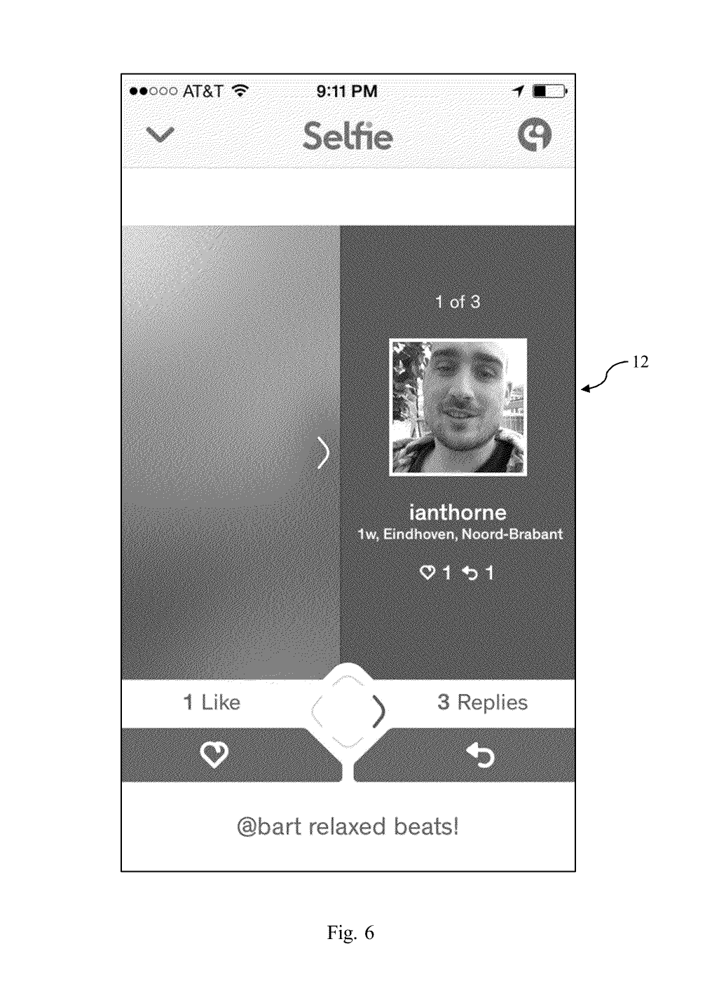

FIG. 6 shows the user interface when a user touches a paused Selfie and, using Selfie's slide navigation functionality, slides his or her finger right, sliding the current Selfie cover left and exposing the details of the Selfie about to load (UI Element 12). These details include the upcoming user's color, the cover of the upcoming Selfie reply and the metadata associated with that Selfie, including username, timestamp, location, Like count and Reply count.

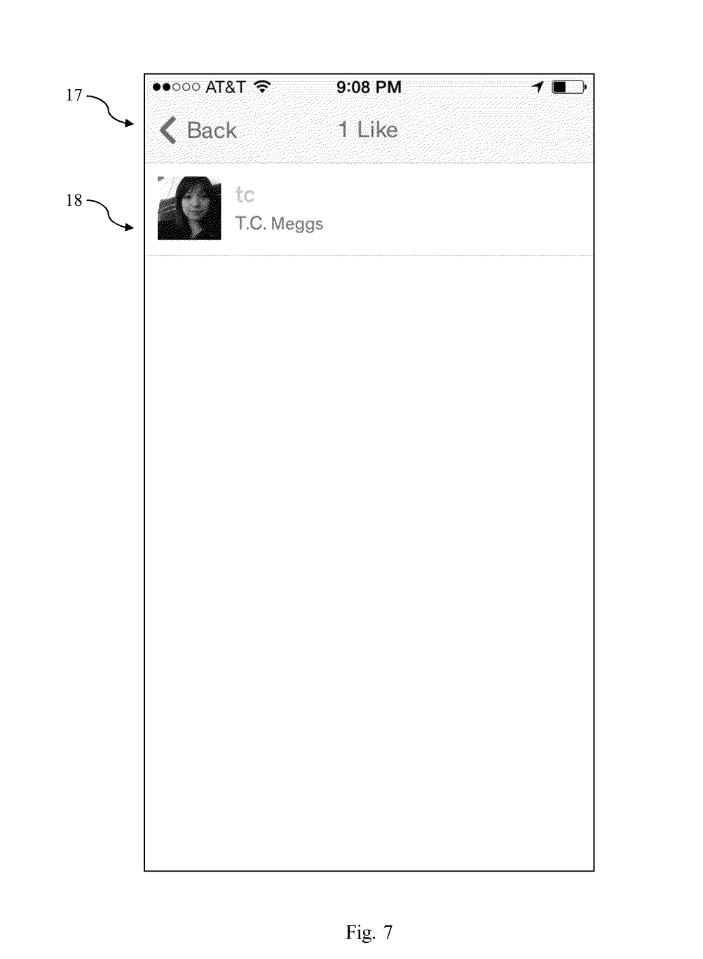

FIG. 7 shows a List of the people who have liked a particular Selfie. This screen is accessible from any Selfie (having at minimum 1 Like) by tapping that Selfie's Like count (FIG. 3, UI Element 7). Across the top of the screen is the navigation bar with text communicating how many likes the Selfie has (UI Element 17). Below the navigation bar is a list of all the users who have liked this particular Selfie, in chronological order of likes. A user is described by his or her username, displayed in that user's chosen color, full name and profile photo, which is not a static image but rather is set as the cover of that user's most-recent Selfie (UI Element 18).

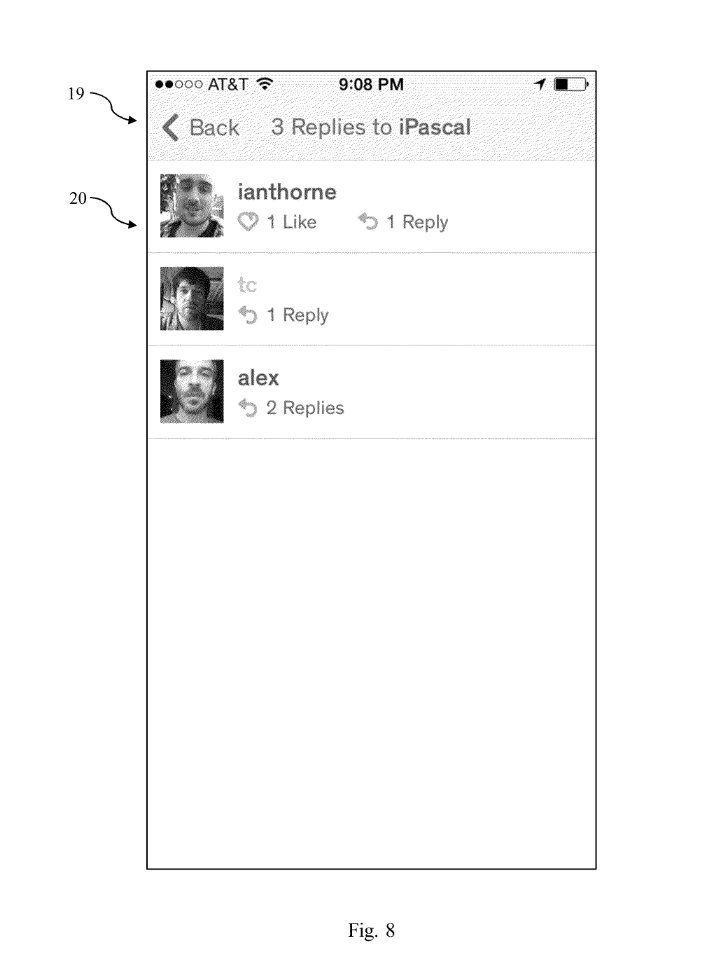

FIG. 8 shows a list of the people who have replied to a particular Selfie. This screen is accessible from any Selfie (having at minimum 1 Reply) by tapping that Selfie's Reply count (FIG. 3, UI Element 5). Across the top of the screen is the navigation bar displaying a count of the number of Replies to a particular Selfie per the user's request from the Feed (UI Element 19). Text in UI Element 19 is displayed in the viewing user's color, except for a username, displayed in that particular user's color. Below the navigation bar is a list of all users who have liked this particular Selfie, ordered by relevance and popularity, with the top Selfies listed first. A user is described by his or her username, displayed in that user's chosen color, a small profile-like photo displaying the cover photo of that user's most-recent Selfie, plus counts of Likes and Replies to each of the listed replies (UI Element 20). The list of Replies displays all users who have Replied to the Selfie in question.

FIG. 9 shows an opened Conversation, the result of the animation described after tapping a Selfie's Conversation button (FIG. 5, UI Element 10). Across the top of the screen is the navigation bar, on which helper text dynamically indicates that a user has accessed the wider Conversation pertaining to a particular Selfie (UI Element 14). Text in UI Element 14 is displayed in the viewing user's color. By default, the helper text says “Conversation” but adjusts as the user scrolls the conversation up, down, left or right, to communicate where the user is going within a Conversation. This is intended to help a user understand what he or she is doing on Selfie.

Below the navigation bar in FIG. 9 is the “Conversation,” where Selfies are connected to one another in the context of a Conversation and are scrollable horizontally (via a single, highlighted center band of Selfies) and vertically in up-to-two stacks of replies. As a Conversation is opened (from FIG. 5, UI Element 10) iPascal, the poster of a Selfie with three replies, shrinks towards the center of the screen, maintaining the cover's square aspect ratio, down to a miniature version of the Selfie cover, as if the user has risen to observe a Conversation from a bird's-eye view. Since iPascal's Selfie was the Selfie the user had been viewing, this position is referred to as the “Center of Conversation” (UI Element 16). In a Conversation, a user's username is displayed on a “Nameplate” in that user's color (UI Element 41). The three replies to iPascal are connected to his Selfie by a circle in his color displaying Selfie's “Reply” glyph (UI Element 42). Replies to a Selfie are displayed vertically in a stack of Replies within a Conversation, with the most popular and relevant Selfies displayed on top, according to user feedback combined with Selfie's ranking algorithm (UI Element 43). Any Selfie can have an unlimited number of Replies, and a user can scroll vertically to navigate the Replies. Tapping the Conversation button (UI Element 10) closes the Conversation to resume Feed view.

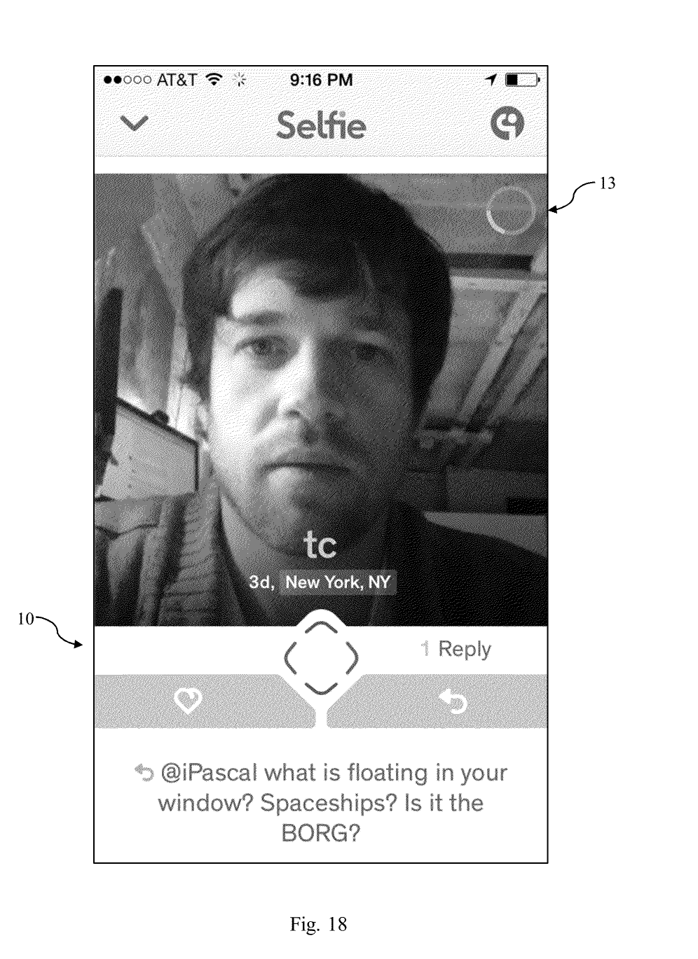

Below the Conversation is text displaying the count of People in this Conversation (UI Element 15). Tapping the Conversation button closes the conversation and zooms back in to revert to Feed view, described in FIG. 3. Tapping any Selfie cover within a conversation expands that Selfie to back to Feed view and begins playback (FIG. 18).

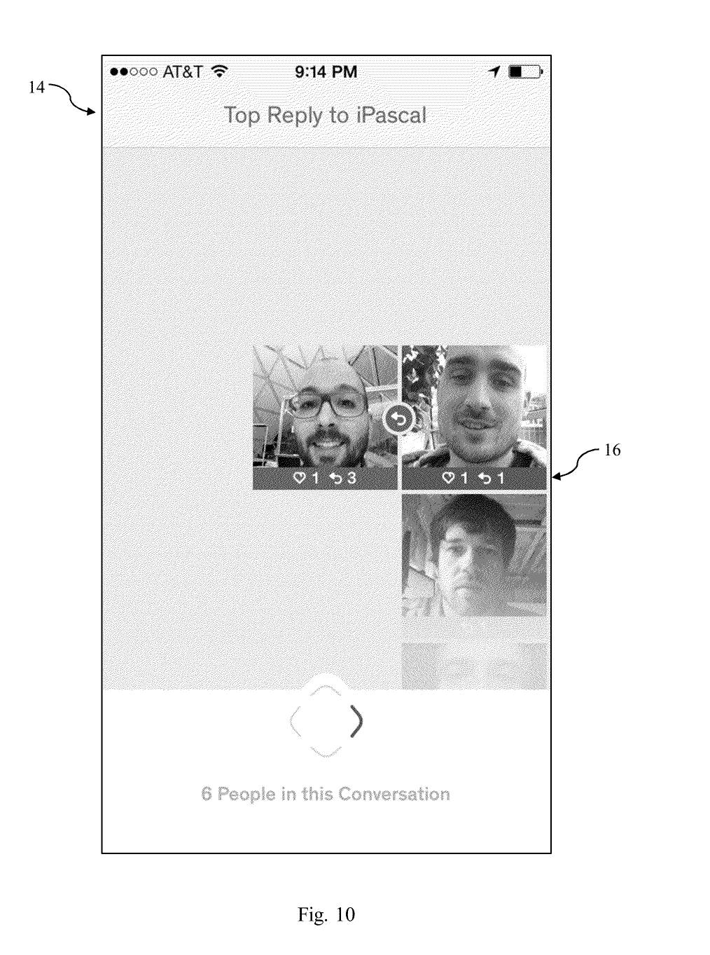

FIG. 10 shows a Conversation while a user is engaging (touching) a Selfie cover, since the Nameplates (FIG. 9, UI Element 41) has adjusted to no longer display the users' usernames, but instead counts of Likes and Replies to each Selfie (if applicable). When a user touches the bands of Selfies in a Conversation, Selfie displays a count of Likes and Replies associated with each Selfie (UI Element 16). Upon release, the Nameplates revert to display usernames. When a user has scrolled to the very top Reply to a Selfie, where the “Top Reply” is determined by Selfie's algorithm based on user participation, the helper text on the navigation bar (UI Element 14) displays “Top Reply to [username]”.

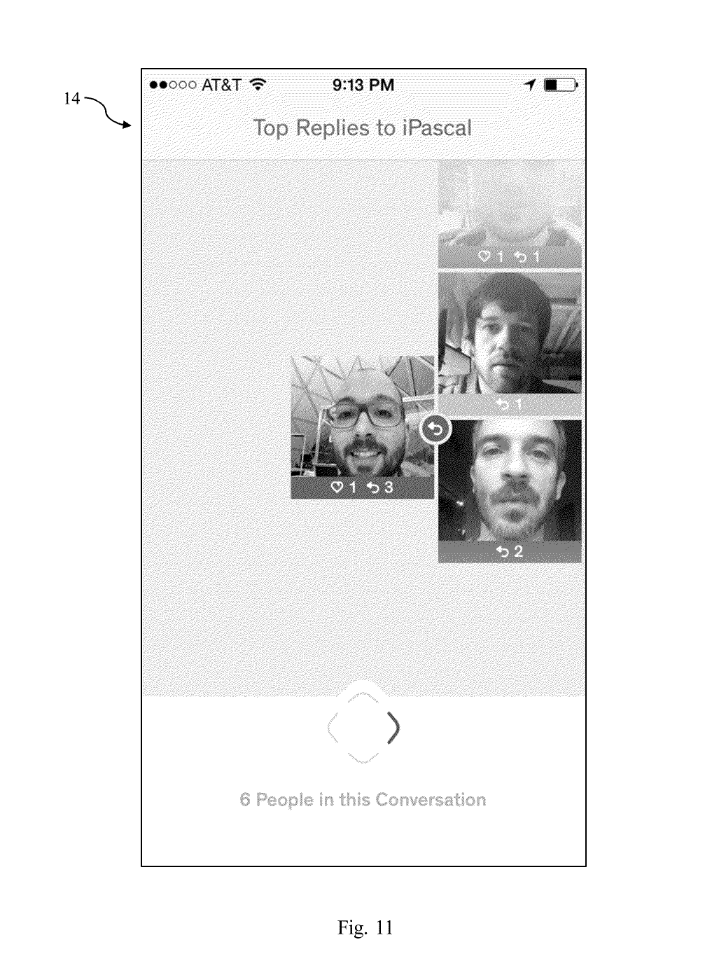

FIG. 11 shows a Conversation while a user is scrolling up from the bottom of a stack of Replies. As a result, the helper text (UI Element 14) has adjusted to communicate that the user is scrolling through “Top Replies to iPascal”. This means that the user is moving up towards the top of the replies since that's where one finds the “top” replies.

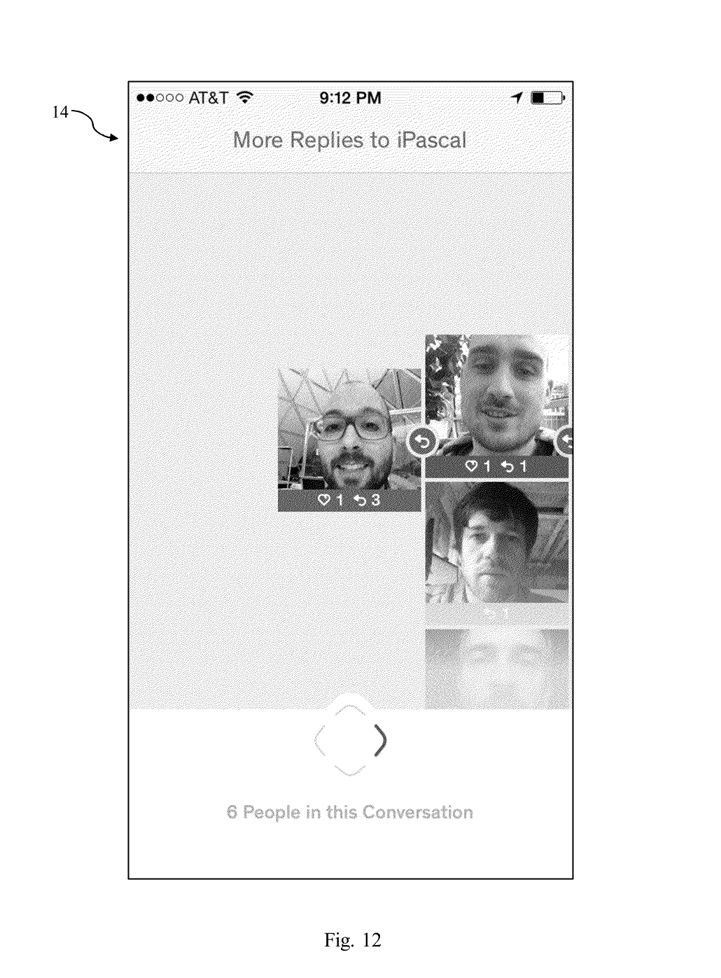

FIG. 12 shows a Conversation while a user is scrolling down from the top of a stack of Replies. As a result, the helper text (UI Element 14) has adjusted to communicate that the user is scrolling through “More Replies to iPascal”. This means that the user is moving down towards the bottom of the replies, looking through “more replies,” where the order of Replies is determined by Selfie's algorithm based on user participation.

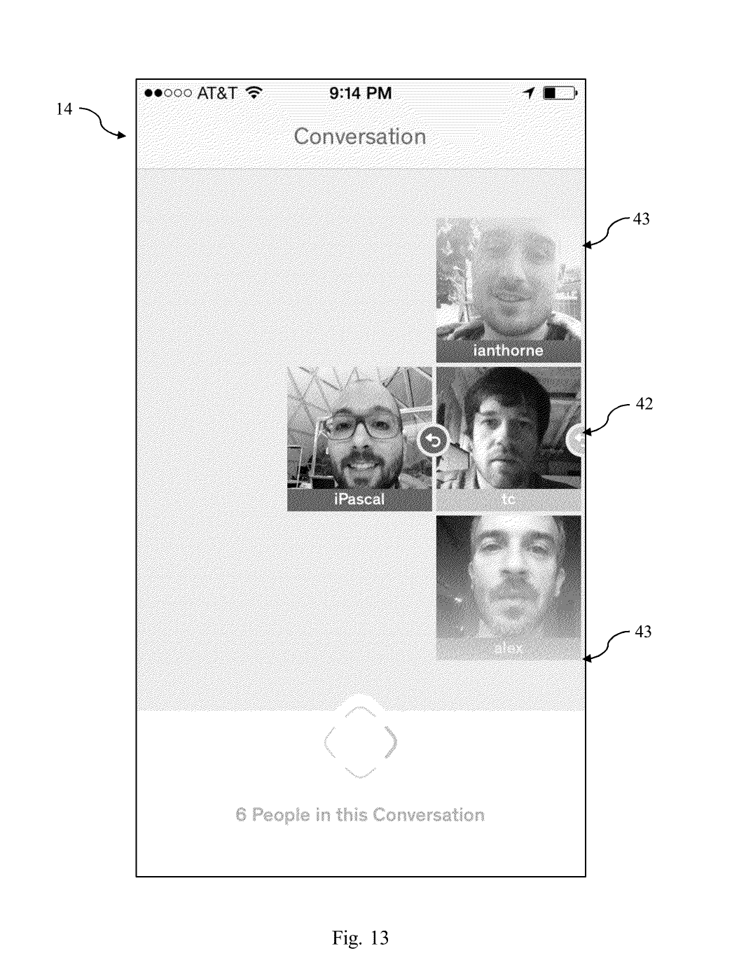

FIG. 13 shows a Conversation after a user has disengaged the vertically scrollable stack of replies to iPascal (FIG. 9). After a user stops scrolling a Conversation and releases his or her finger, the helper text on the navigation bar, UI Element 14, fades back to the title “Conversation” from one of the four Conversation helper messages displayed as a user moves “Back” or “Forward” in Conversation, or browses “Top” or “More” replies to a user's Selfie. Since the user has switched which reply is in the horizontal band of Selfies (from ianthome, the top reply to iPascal, to tc, the second reply to iPascal) the Conversation displays a circle with a reply glyph in tc's color, visually indicating that there exist replies to tc as well, if the user were to scroll to see content currently off-screen (UI Element 42). Switching between Replies to a Selfie within a Conversation changes the pathway of a Conversation. For example, as tc becomes the Reply next to iPascal, the color of the right arrow in the Conversation button and the Reply Arrow changes to match tc's color. As a user scrolls vertically through a vertical stack of Selfie replies, the conversation fades out into white at the upper and lower bounds, helping to focusing the user's attention on the central, horizontal band of Conversation linked by reply arrows. (UI Element 43).

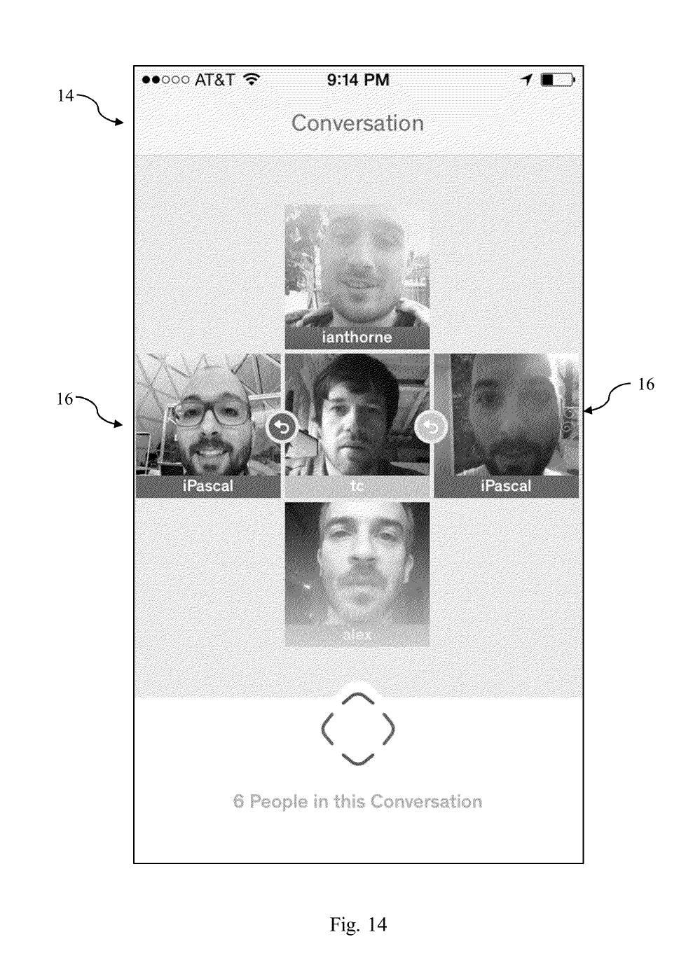

By touching the central band of Selfies in FIG. 13, UI Element 43 and swiping from right to left, a user goes forward in Conversation to FIG. 14. UI Element 14 displays helper text that the user is going “Forward in Conversation” before reverting back to its “Conversation” resting state. By moving the horizontal band of Selfies, tc becomes the center of conversation and we observe that there is one reply to tc: iPascal.

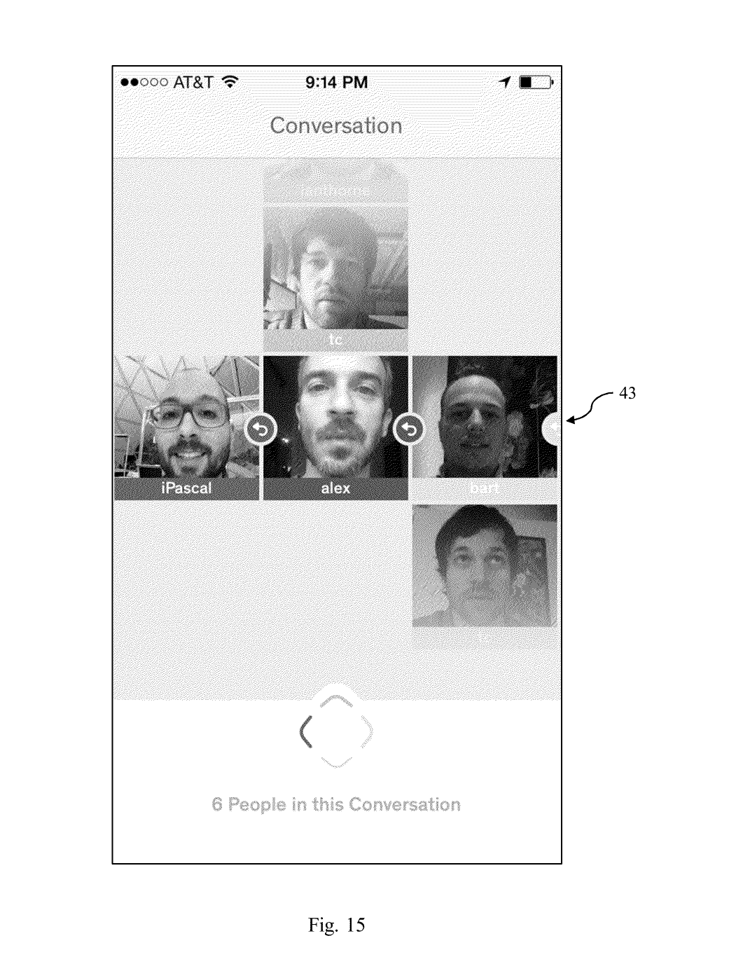

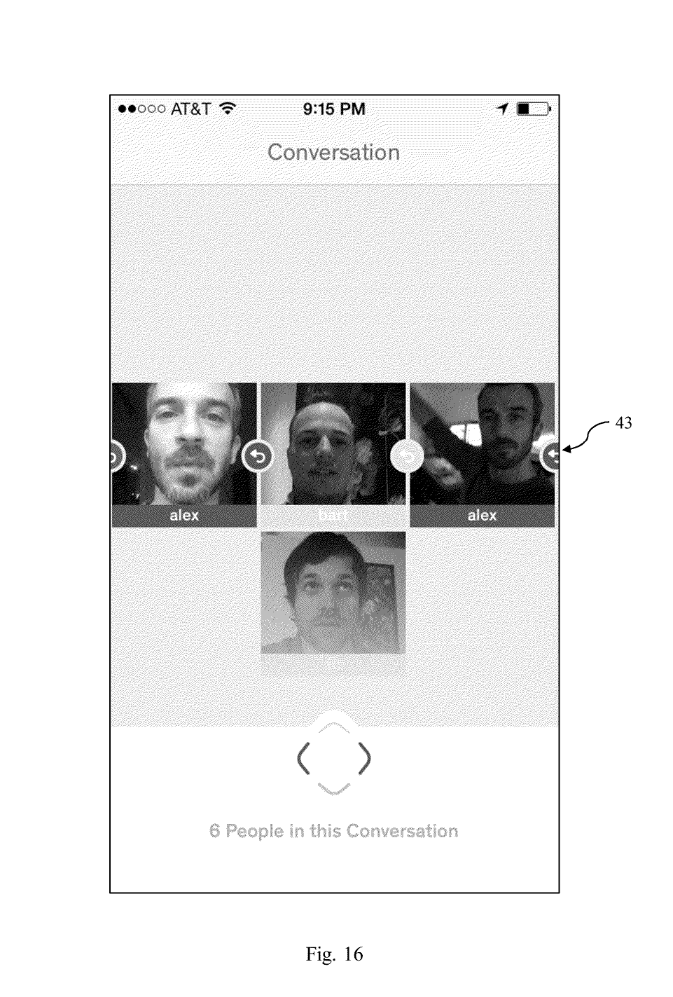

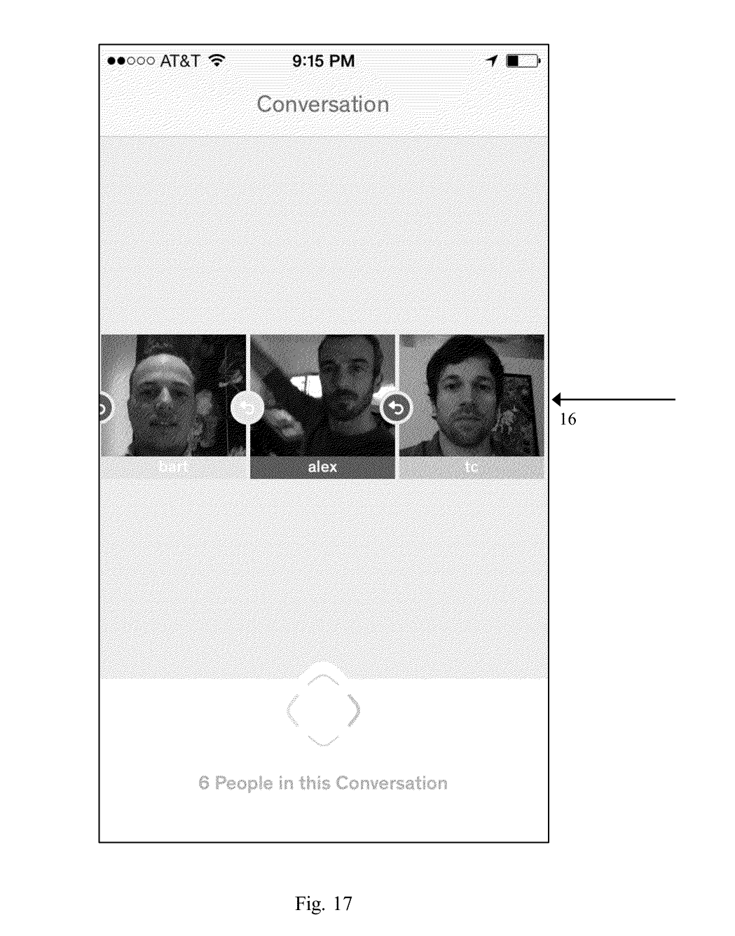

By touching the vertical stack of replies to iPascal in FIG. 14 and scrolling down, changing the Center of Conversation from tc to alex, the Conversation loads replies to alex, in this case “bart” and “tc.” (in FIG. 15) UI Element 43, a yellow circle with a reply glyph bleeding off the right side of the screen, indicates that there exist replies to bart if a user were to scroll forward in Conversation. The result of doing so is FIG. 16, where the yellow circle also indicates additional replies to alex (UI Element 43). Scrolling forward in conversation again produces FIG. 17. Just as a user may scroll “Forward in Conversation” by scrolling horizontally to the right, a user may scroll “Back in Conversation” by scrolling to the left, i.e., a user can scroll the horizontal conversation band left and right by touching and scrolling on the center band (UI Element 16). Helper text in the navigation bar, UI Element 14, communicates that a user is going “Back in Conversation” as this occurs. When a user scrolls back in Conversation, a new user becomes the center of the Conversation, loading replies to that user in the right column and changing the Conversation button arrows accordingly.

By touching a Selfie within the Conversation, the touched cover expands to fill the Feed view and Selfie playback begins (FIG. 18). UI Element 13, a spinning circle in the color of the user whose Selfie is currently engaged communicates to the user that the Selfie has been engaged and this Selfie has begun playback. As there are four directions this user can move within the Conversation, the Conversation button (UI Element 10) uses four arrows to indicate the four directions a user may navigate from this Selfie.

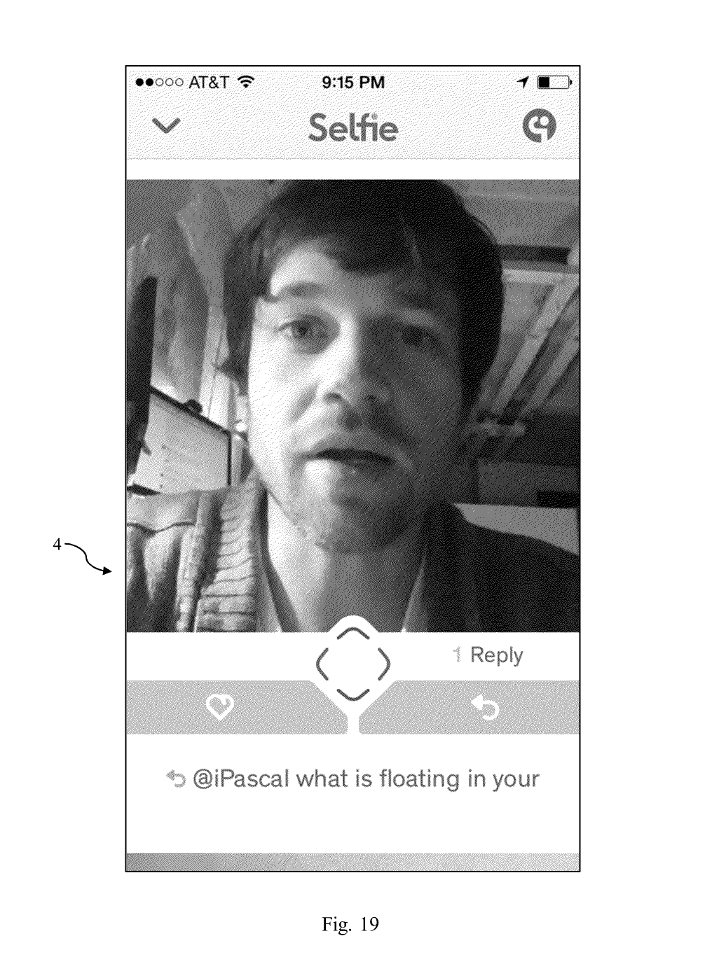

As a Selfie begins playback (FIG. 19), user metadata displayed on the cover (UI Element 4) fades away.

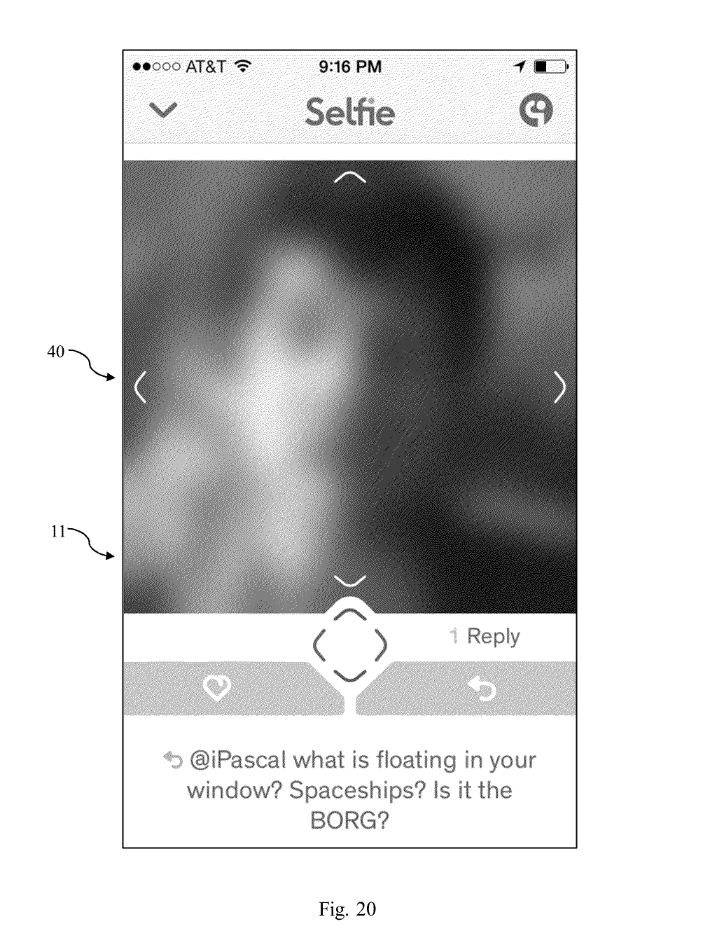

Upon completion of playing a Selfie or at any time during playback by touching a playing Selfie, a user enters a paused state (FIG. 20). In the paused state, the Selfie video stops playing audio, freezes the video at the frame at which the Selfie was paused, and employs a blurred, frosted-glass-like effect that removes the user's attention from the person the user just watched, and towards navigation options concerning where to move next. In the event that a user may slide navigate to adjacent Selfies, glowing navigation arrows (UI Element 40) emerge to communicate to the user where he or she may move next and the color of the user to be encountered there. These arrows mirror the colors and locations communicated on the Conversation button (UI Element 10). As a secondary method of slide navigation within a Selfie feed view, tapping these glowing reply arrows initiates slide navigation between adjacent Selfies without the user having to go through the action of actually sliding and releasing. By tapping a paused Selfie, a user leaves the paused state and resumes playback.

When a user viewing Selfies slides his or her finger to the right on a paused Selfie, that viewer begins to expose details about the Selfie that preceded the recently watched (and currently-paused) Selfie in a Conversation of Selfies (FIG. 21). As the blurred and paused cover slides off the screen to the right, metadata about the upcoming Selfie fades into place and is dynamically centered over a field of the upcoming user's color as the user slides his or her finger horizontally (UI Element 12). Upon releasing his or her finger, the requested Selfie cover expands to fill the feed and begins playback. As in the Conversation view (FIG. 9 and related), when a user slide navigates to the left, he or she is moving “Back in Conversation”.

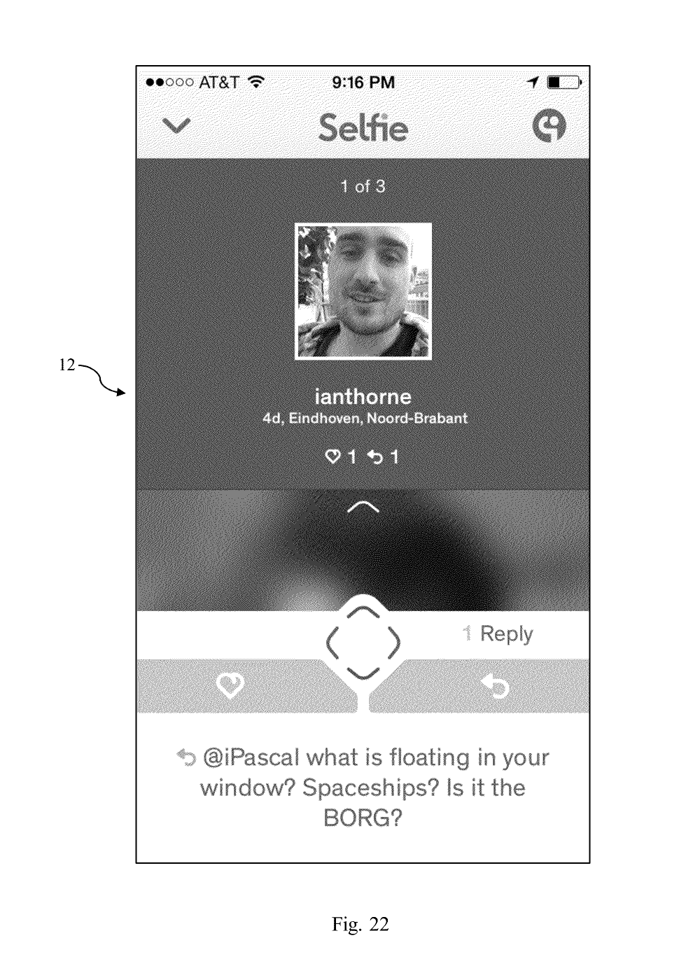

When a user viewing Selfies slides his or her finger down on a paused Selfie, that viewer begins to expose details about another Selfie that is also replying to the recently watched (and currently-paused) Selfie in a Conversation of Selfies (FIG. 22). As the blurred and paused cover slides off the screen to the bottom, metadata about the upcoming Selfie fades into place and is dynamically centered over a field of the upcoming user's color as the user slides his or her finger vertically. (UI Element 12). Upon releasing his or her finger, the requested Selfie cover expands to fill the feed and begins playback. As in the Conversation view (FIG. 9 and related), when a user slide navigates up, he or she is loading “Top Replies” to a particular Selfie.

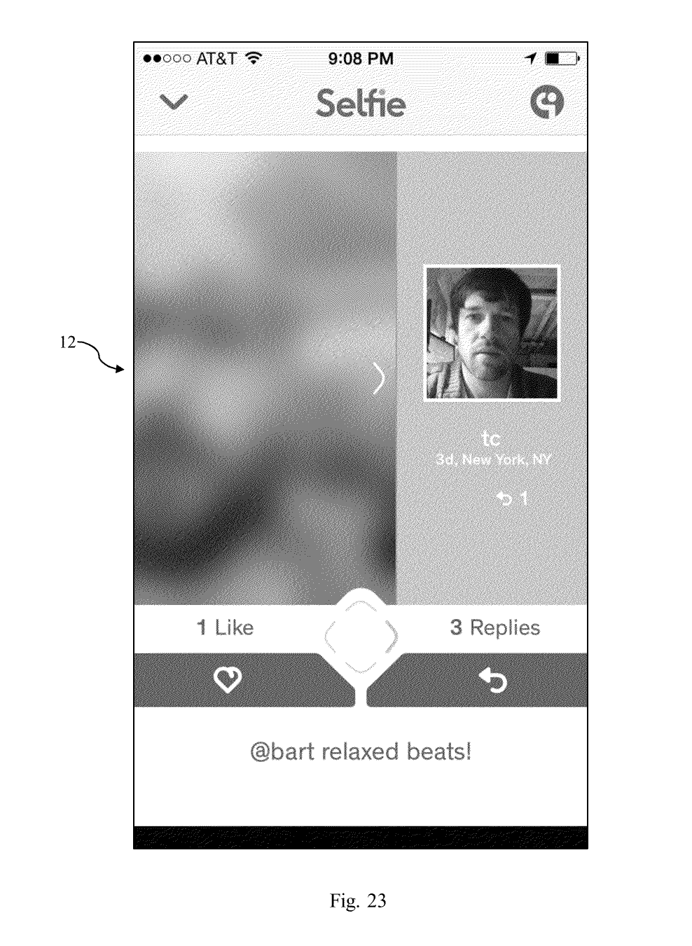

When a user viewing Selfies slides his or her finger to the left on a paused Selfie, that viewer begins to expose details about a Selfie that is replying to the recently watched (and currently-paused) Selfie in a Conversation of Selfies (FIG. 23). As the blurred and paused cover slides off the screen to the left, metadata about the upcoming Selfie fades into place and is dynamically centered over a field of the upcoming user's color as the user slides his or her finger horizontally. (UI Element 12). Upon releasing his or her finger, the requested Selfie cover expands to fill the feed and begins playback. As in the Conversation view (FIG. 9 and related), when a user slide navigates to the right, he or she is moving “Forward in Conversation”.

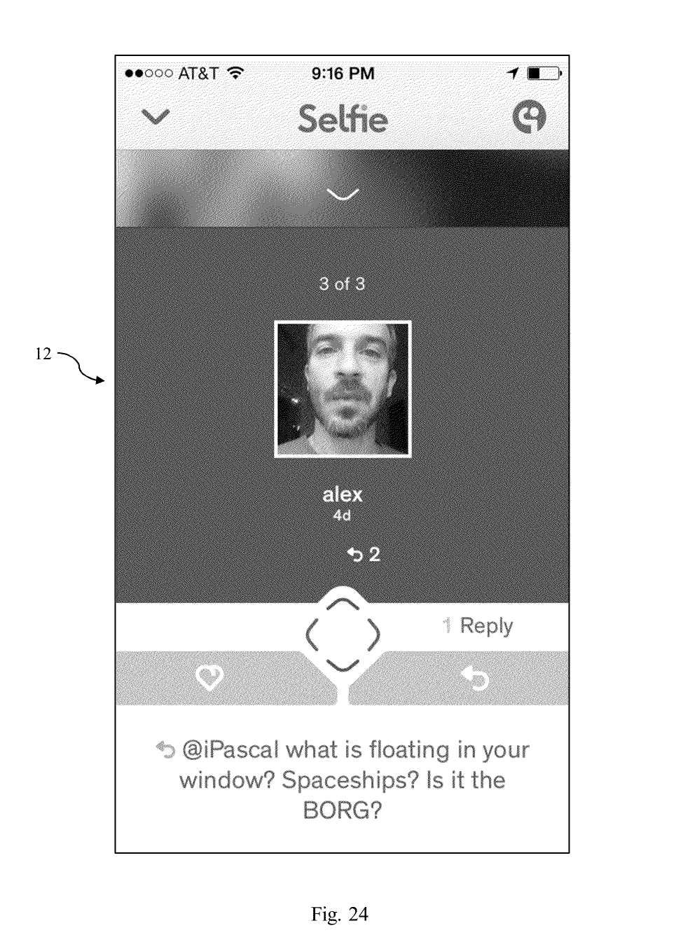

When a user viewing Selfies slides his or her finger up on a paused Selfie, that viewer begins to expose details about another Selfie that is also replying to the recently watched (and currently-paused) Selfie in a Conversation of Selfies (FIG. 24). As the blurred and paused cover slides off the screen to the top, metadata about the upcoming Selfie fades into place and is dynamically centered over a field of the upcoming user's color as the user slides his or her finger vertically. (UI Element 12). Upon releasing his or her finger, the requested Selfie cover expands to fill the feed and begins playback. As in the Conversation view (FIG. 9 and related), when a user slide navigates down, he or she is loading “More Replies” to a particular Selfie.

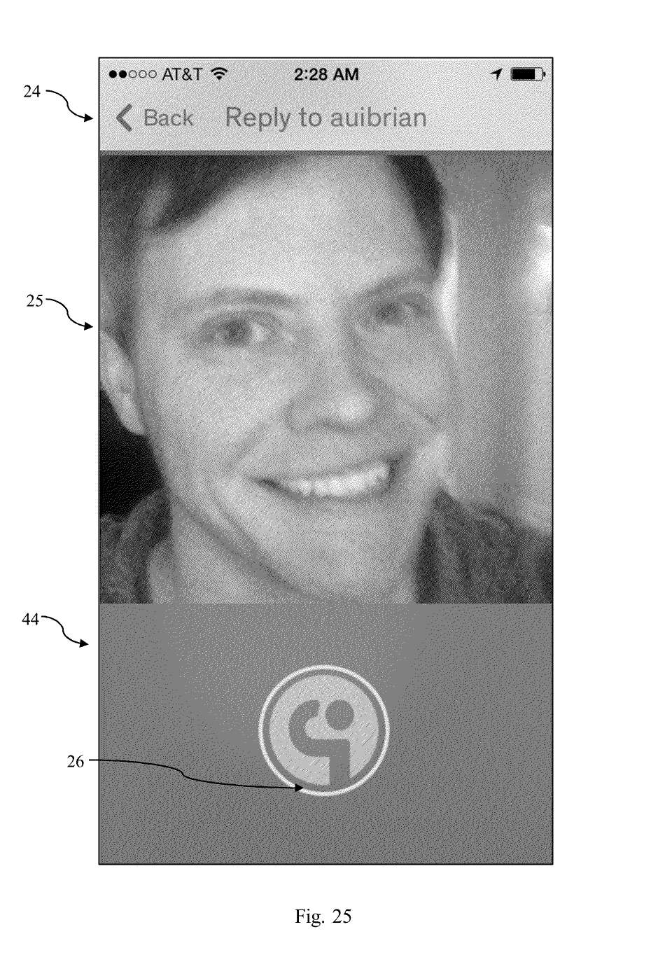

A user may record Selfies through a recording process. A user may access the recording process either by tapping the Shoot a Selfie button (FIG. 3, UI Element 2) to begin a new Conversation disconnected from any existing Selfies or by tapping the Reply button below any posted Selfie (FIG. 3, UI Element 6) to reply to an existing Selfie with a new Selfie. FIG. 25 shows the initialized state before recording begins. Helper text on the navigation bar (UI Element 24) communicates to the user whether the Selfie they are about to record is a reply to an existing user, by displaying “Reply to <username>” where “username” is displayed in the color of the specified user. If the Selfie about to be recorded is not a reply, the helper text instead displays “Shoot a Selfie.” Below the navigation bar is a square recording area extending fully to the left and right edges of the screen (UI Element 25). A user sees a “mirror-image” of him or herself via video captured exclusively through the front-facing camera of the user's smartphone and displayed in real time. During this stage of the recording process, a user may choose to properly frame him or herself in the recording area, ensure he or she is happy with his or her current appearance and ensure proper lighting and staging conditions are satisfactorily met. When the user is ready to begin actually recording, the user presses the Shoot a Selfie button (UI Element 26) overlaid on a field of the users color with frosted-glass and transparency effects applied (UI Element 44).

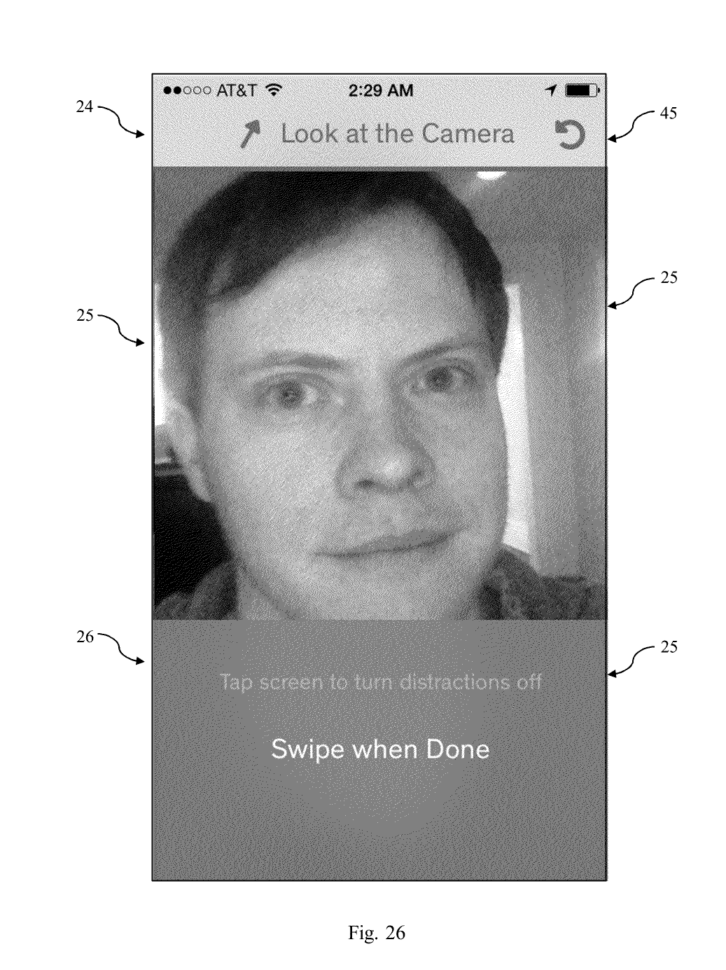

Upon initiating a recording session by tapping the Shoot a Selfie button (FIG. 25, UI Element 26), helper text (UI Element 24) on the navigation bar changes state to encourage the user to “Look at the Camera” through a combination of text and visual cues pointing up to the smartphone's front facing camera. On the right side of the navigation bar, a Restart button, a glyph of an arrow in a circular orientation, appears (FIG. 26, UI Element 45). Upon tapping the restart button, previously captured and recorded video from this recording session is immediately discarded and recording begins anew with another “Look at the Camera” helper message. This allows the user to easily record multiple takes before getting a Selfie just right. The area showing the user's recorded short video may be square-shaped and will allow the user to see him or herself using the smartphone's front-facing camera (UI Element 25). The user may also add visual effects in the Color field (UI Element 44). Upon tapping Shoot a Selfie (FIG. 25, UI Element 26), the Shoot a Selfie button fades out and is replaced with text communicating to the user that he or she may tap the screen to turn “Distractions Off” and he or she may swipe when done recording (to advance to the next step of the recording process). A semi-transparent screen will cover the user's face, allowing the user to focus on the camera, not him- or herself, while maintaining sufficient visual information so that the user knows he or she is still in the frame.

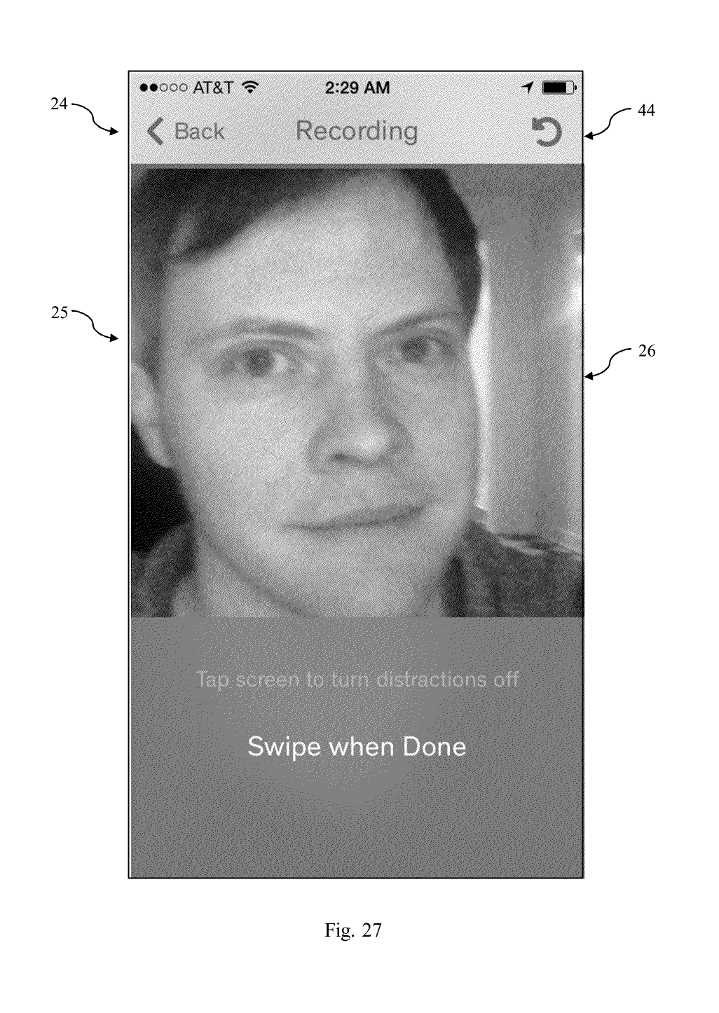

While a user is recording (FIG. 27) the helper text on the navigation bar (UI Element 24) simply reads “Recording”. Directly below the navigation bar is a thin horizontal bar in the recording user's color to serve as a Recording Timer that counts down time from right to left (UI Element 44). During recording, the Recording Timer communicates to the user how much time remains by shrinking progressively smaller from right to left as time passes over a 24-second period. When the user only has 5 seconds remaining, the Recording Timer begins to flash once every second. Upon pressing the Restart button (UI Element 45), the Recording Timer once again extends all the way to the right side of the screen and begins to shrink as recording begins again. The user can see him or herself preferably using the smartphone's front-facing camera (UI Element 25). A user need not record for the full 24 second window. At any point a user may swipe his or her finger horizontally right to left to finish recording and move to the next step of the recording process (UI Element 26). At the end of 24 seconds, if a user has not manually swiped to the next step, Selfie performs this action on the user's behalf.

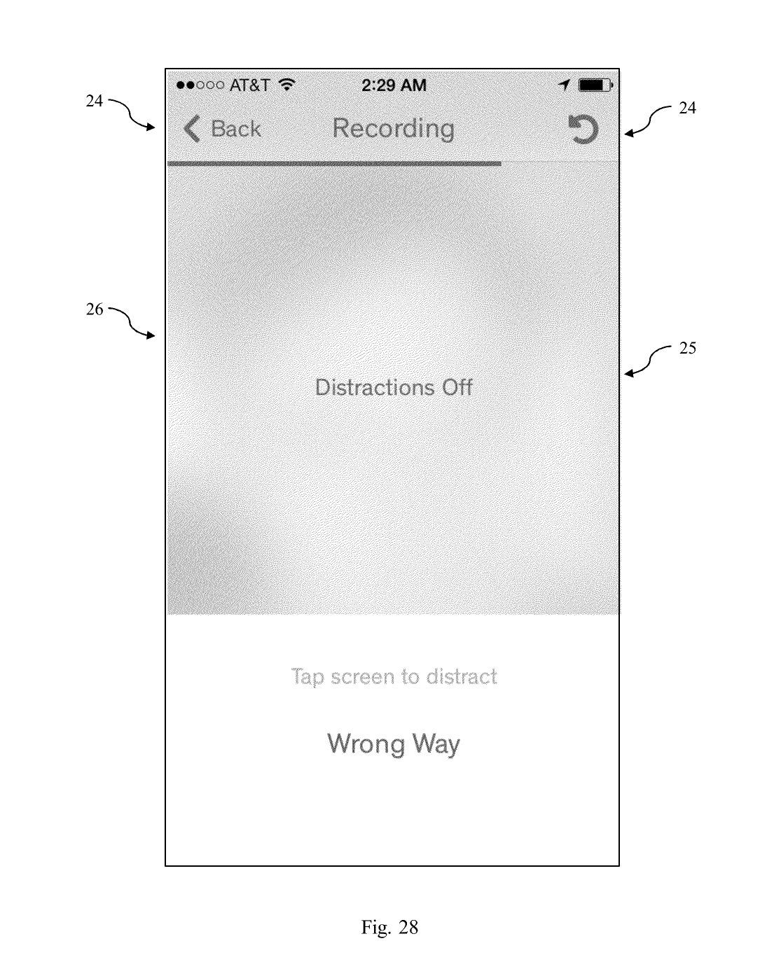

At any point while recording, a user may tap the screen to turn Distractions Off. By entering “Distractions Off” mode, a user has requested that a semi-transparent blurred layer rise from the colored field below the Recording Area to obscure the subject matter (the user) during the recording process. The result of taking this action is FIG. 28, Distractions Off mode. Without Distractions Off mode, users have a common tendency to make eye contact with their likeness on screen and not the front-facing camera that is actually capturing the video. By removing the distracting visual feedback from the user during the recording process, the user is able to focus his or her attention on the camera, not on the screen. The result is that people appear much more natural and human in their Selfies. The Distractions Off layer is not completely opaque, allowing for some visual contextual information to remain, so a user can ensure he or she is continually framing him or herself properly. While Distractions Off mode is engaged, the message “Distractions Off” is also displayed in the center of the screen. At any time a user may tap the screen again to remove the Distractions Off layer and resume a recording session with full visual feedback (UI Element 26). When done, a user swipes his or her finger right to left to finish the recording session and proceed to the next step of the recording process. Swiping the wrong way to stop recording (left to right) produces a “Wrong Way” message (UI Element 25).

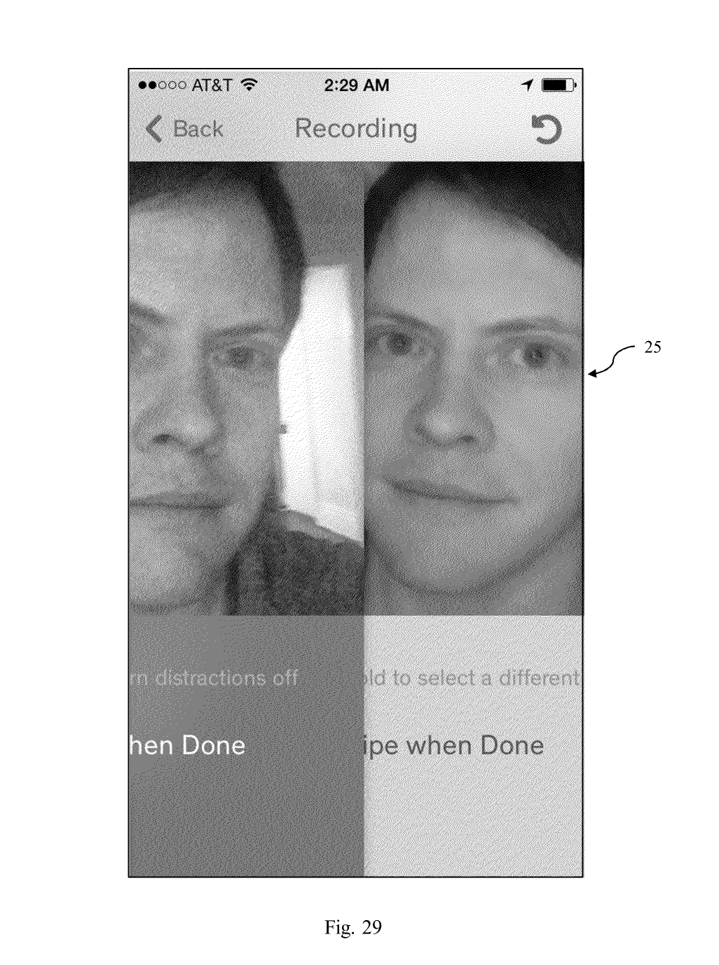

When a user swipes from Step 1 of the recording process (Recording) to Step 2 (Review), he or she does so by swiping his or her finger from right to left, creating an animation giving the impression that a user is sliding the current step off the screen to the left, exposing a new layer that fades in while sliding into place from the right (FIG. 29) The intended visual effect is that as soon as a user swipes to conclude recording, the captured Selfie is displayed, available for review. As a user swipes to end recording, the Selfie is readied for playback and review even before recording fully stops (UI Element 25).

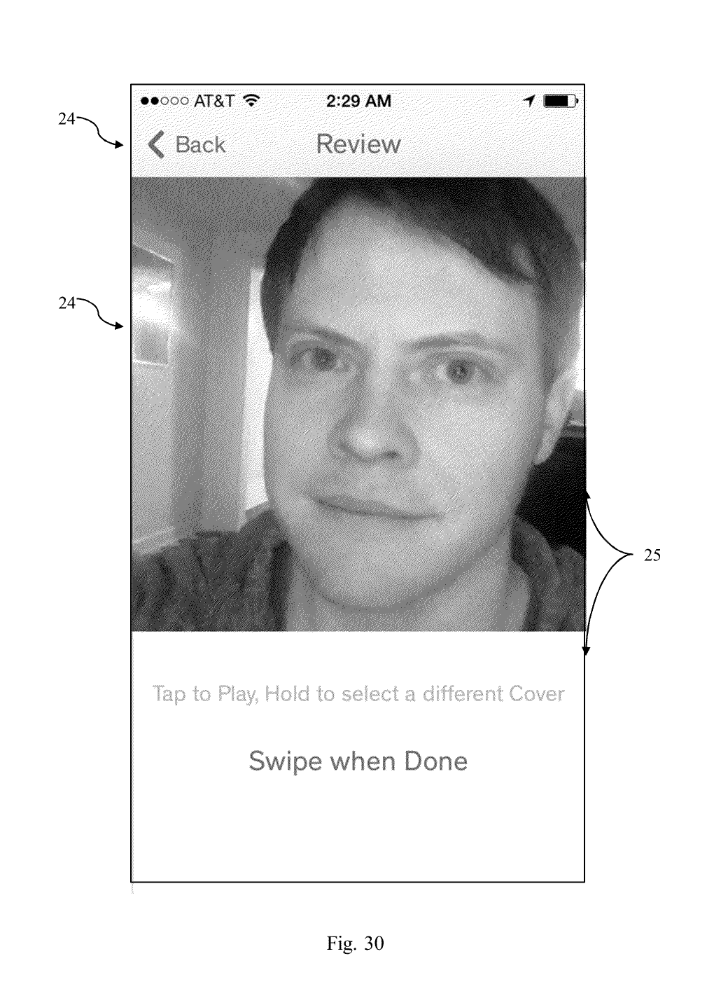

During the “Review” step of the recording process (FIG. 30), helper text on the navigation bar displays “Review” (UI Element 24). Swiping back or tapping “Back” returns the user to the previous Recording step.

Under the navigation bar, a user may review the recently recorded Selfie by tapping the static auto-suggested cover (UI Element 25), initiating playback of the recently-recorded Selfie. At any time, a user may choose a different cover by pressing and holding the Selfie to produce a Cover Picker (FIG. 31). If a user decides to re-record his or her Selfie, he or she may press the “Back” button on the navigation bar or swipe his or her finger from left to right, moving back in the recording process to Step 1 (Recording). When a user is happy with the Selfie and cover selected, he or she may swipe his or her finger right to left to initiate an animated transition (FIG. 33) to Step 3 of the recording process (Add Detail) identical to the animation that also occurs between Steps 1 and 2.

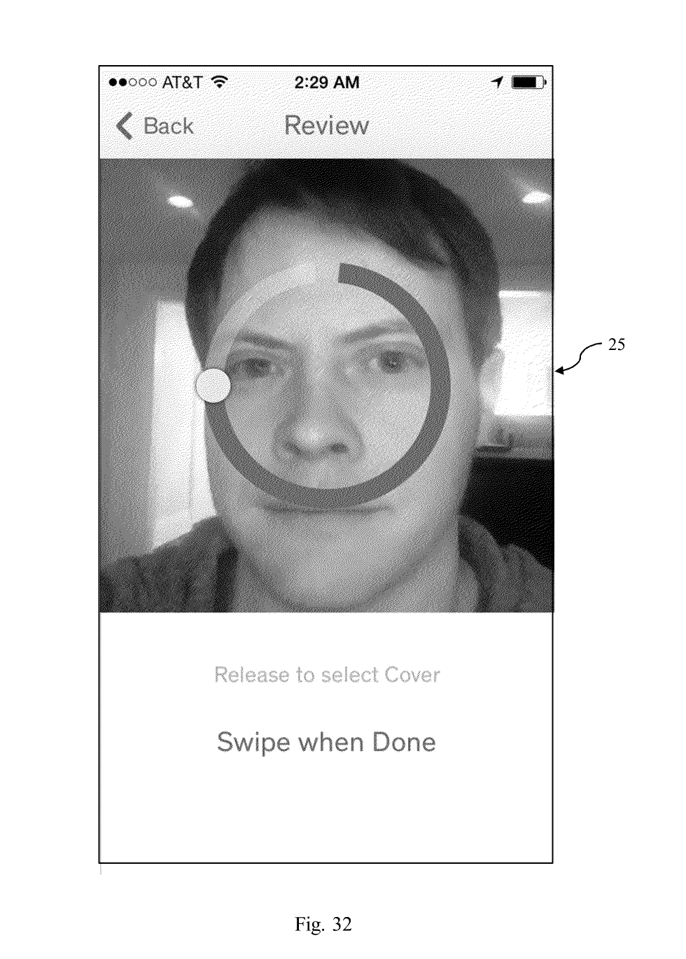

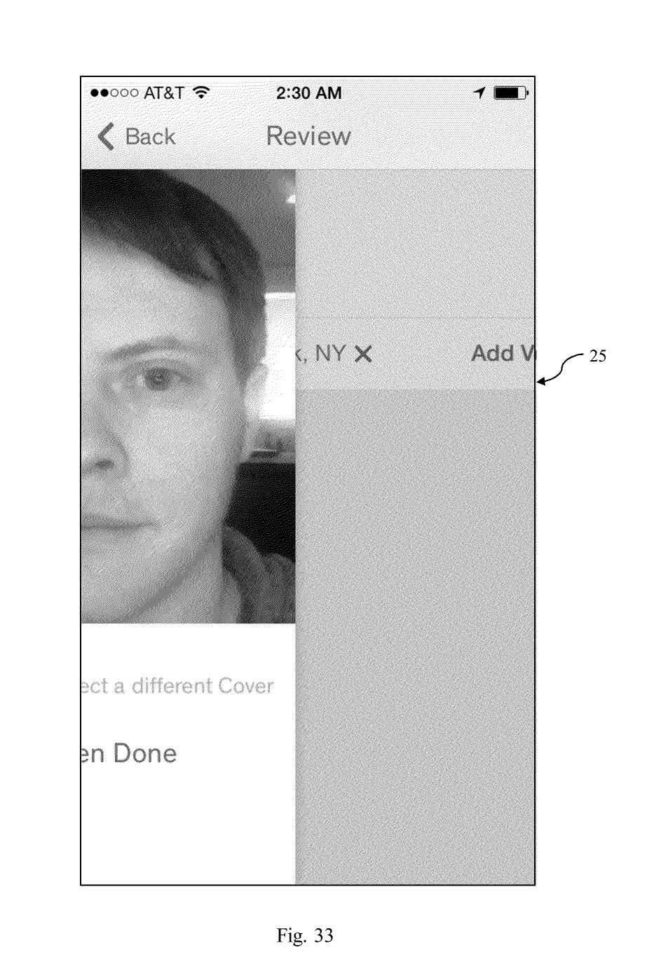

Upon pressing and holding the Selfie during the Review step (FIG. 31), a circular, semi-transparent Cover Picker (UI Element 45) unravels in a clockwise direction to allow the user the tool to specify any frame of his or her Selfie as the cover to be displayed in users' feeds. By touching the Cover Picker's Dial (UI Element 46) a user may scroll forward and back, clockwise and counterclockwise respectively, through the recently recorded Selfie (FIG. 32). Also in FIG. 31, swiping from right to left advances the user to the last step of recording (UI Element 25). As a user scrolls through frames of recorded video, the Dial moves to show the position within the video as the user's color fills in the Cover Picker to reflect the portion of video the user has scrolled through (UI Element 25). The Cover Picker has a beginning and an end with a break at its top and it does not allow the user to compete an entire circular rotation. Upon choosing a desired cover, the user releases his or her finger from the Cover Picker's Dial to confirm the desired cover and close the Cover Picker through a counterclockwise-disappearing animation. The Selfie now displays the user's selected cover. Pressing and holding the Selfie again re-engages the Cover Picker again. A user swipes to Step 3 (FIG. 33) when done.

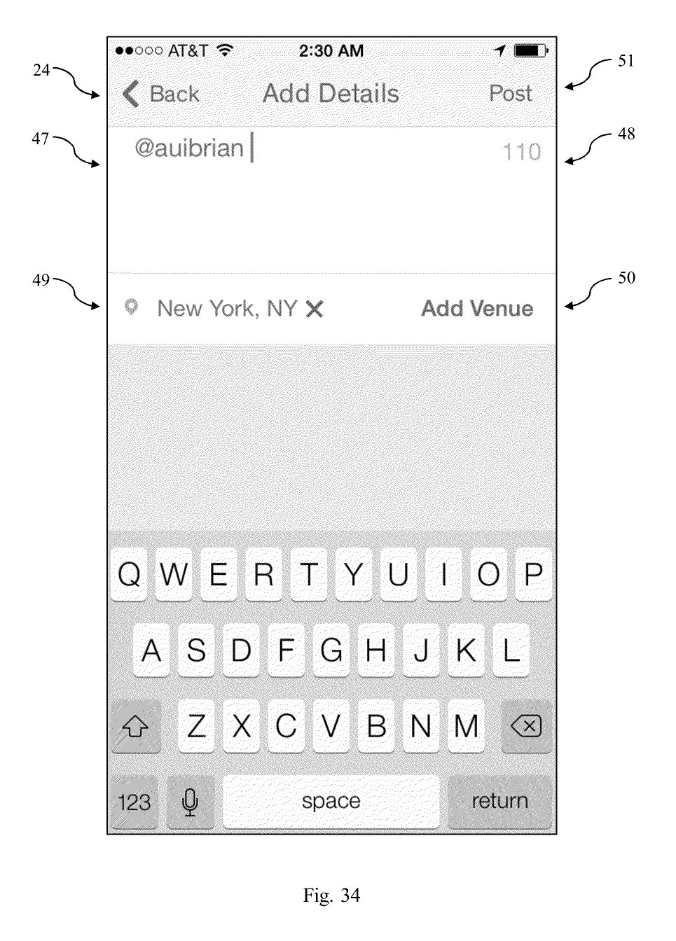

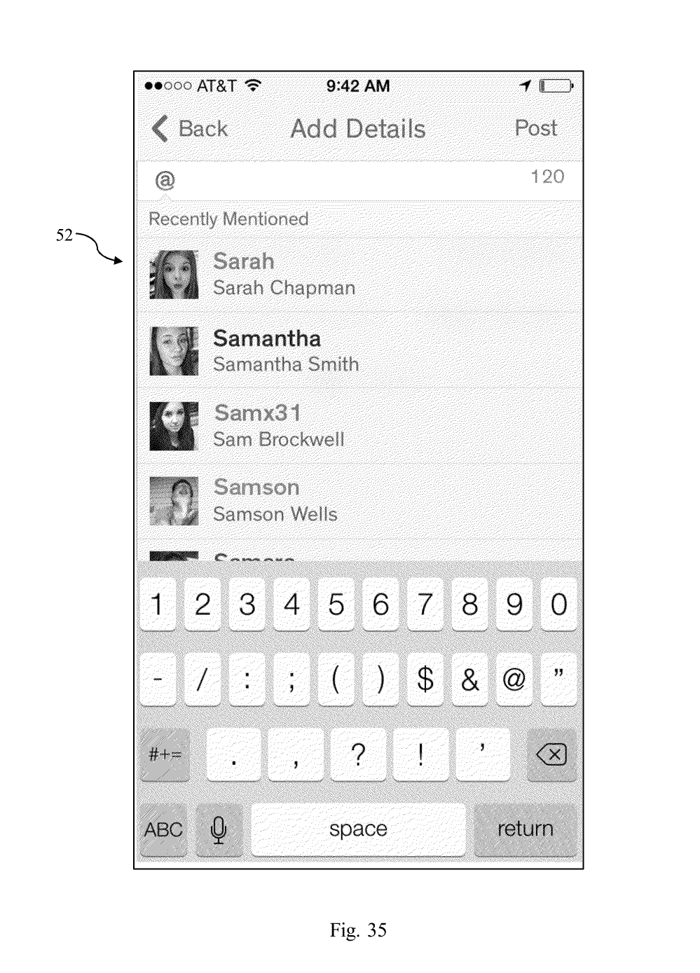

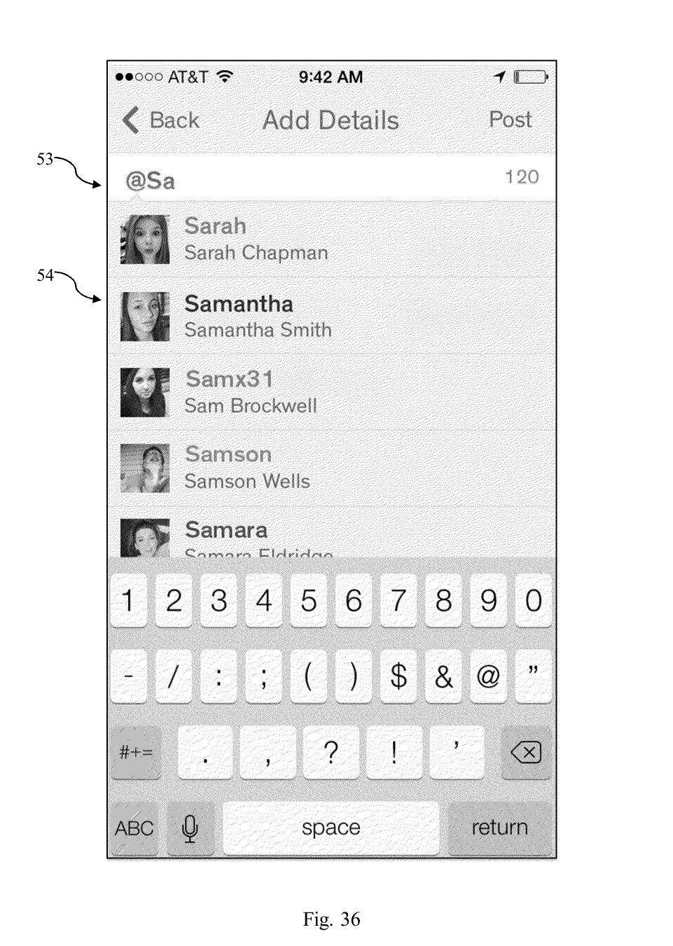

Step 3 of the Recording Process (FIG. 34) allows the user to add contextual metadata to his or her Selfie and ultimately post it for others to view. Helper text on the navigation bar (UI Element 24) reads “Add Details.” After adding desired details, the user may post the Selfie by clicking on “Post” (UI Element 51). A user may enter a text caption of up to 120 characters (UI Element 47) that supports social media standards such as @mentioning other users (a common form of one-to-one or one-to-many social alerts), #hashtags (a common freeform method of organizing and exploring concepts and topics), URLs (a common way for users to share content residing on other websites) and emoji (a commonly used visual icon language). As a user types his or her text caption, a caption character count counts down from 120, informing the user how many characters he or she has remaining (UI Element 48). When entering a caption, when a user enters the “@” symbol, the @Mention Helper pops up, displaying a list of Selfie user usernames that Selfie believes the posting user may be looking to easily find and add to his or her caption (FIG. 35). Users are displayed in a list, with each user described by his or her most recent cover, username and full name (UI Element 52). Tapping users adds the requested user to the caption and closes out of the @Mention Helper. Typing a space after the @ symbol will also break standard @Mention conventions and exit from the @Mention Helper to resume standard caption entry (FIG. 34). When a user begins to type characters (FIG. 36, UI Element 53) Selfie dynamically displays search results character by character (UI Element 54) including a located user's most-recent cover, username and full name.

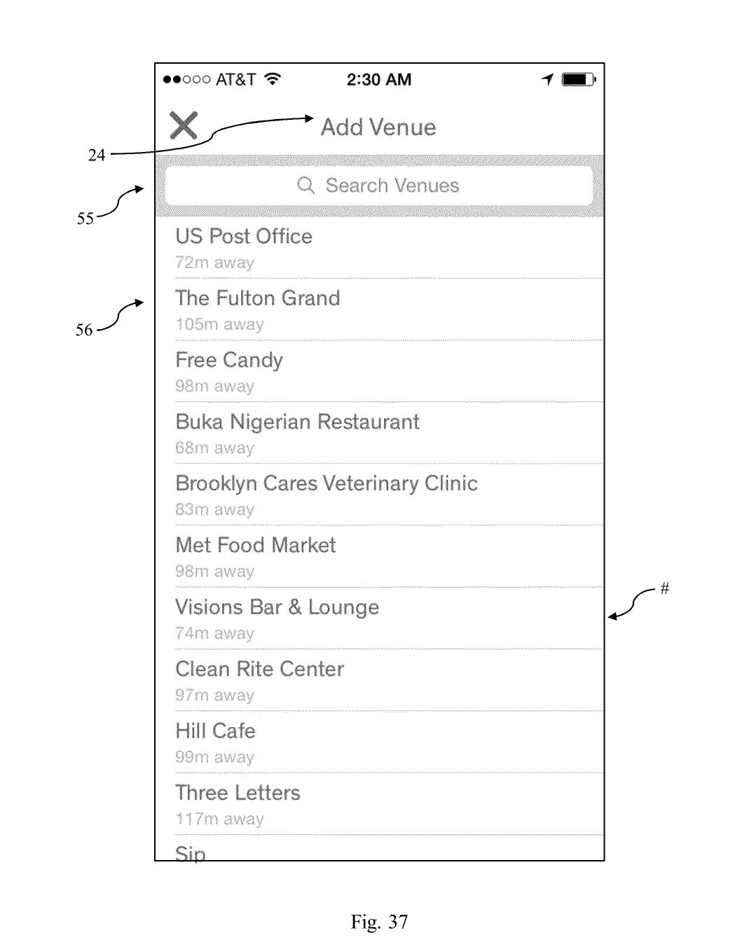

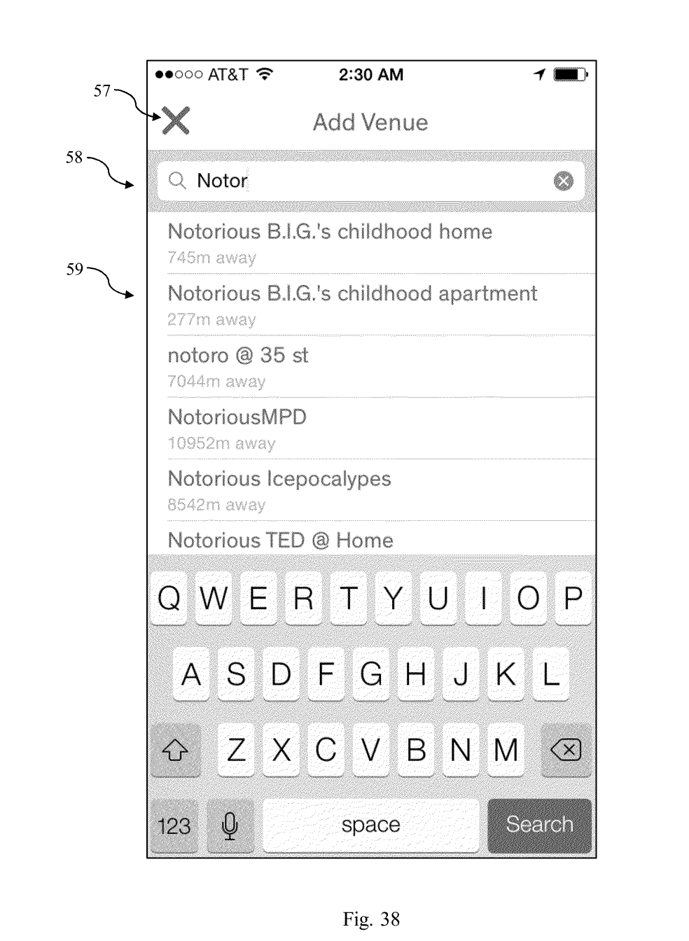

Below the caption (FIG. 34, UI Element 47) is displayed the location of the Selfie next to a grey location pin glyph (UI Element 49). By default, Selfies are automatically tagged at the “city” level (in this case New York, N.Y.) but a user may remove the location altogether by tapping the X button. In the event that a user wishes to designate a specific venue as the location for his or her Selfie, tapping “Add Venue” (UI Element 50) allows the user to browse and search nearby venues (FIG. 37).

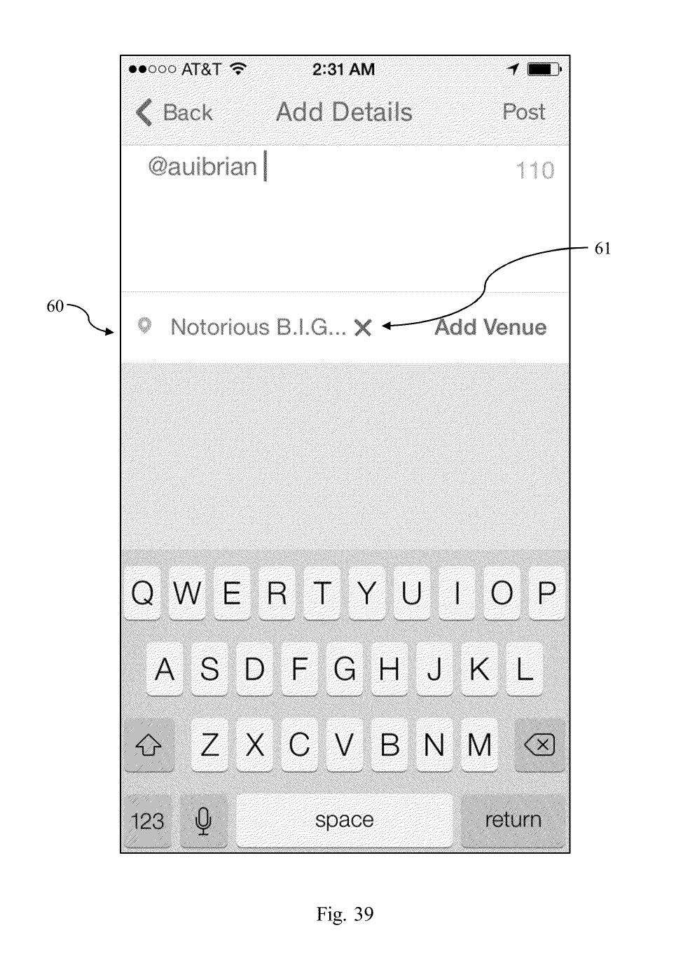

When a user taps “Add Venue” (UI Element 50) he or she will access a list of nearby venues that the user might be trying to find (FIG. 37). Helper text on the navigation bar (UI Element 24) reads “Add Venue.” A user may search for a specific venue by tapping the search box (UI Element 55). Below the search box is a list of suggested nearby venues (UI Element 56). Each suggestion displays the venue's name and distance from the user. Upon tapping a venue, the venue is selected and the user is returned back to the Add Details screen, where the venue name has replaced the city name in the Selfie's location (FIG. 39, UI Element 60). A user may remove the selected venue and revert to the suggested city by tapping the X glyph (FIG. 39, UI Element 61).

If a user instead decides to search for a specific venue by name (FIG. 38, UI Element 58), Selfie dynamically returns search results character by character (UI Element 59), displaying each venue's name and distance from the user. Upon tapping a venue, that venue is selected and the user is returned back to the Add Details screen, where the venue name has replaced the city name in the Selfie's location (FIG. 39, UI Element 60). The selected location may be removed by tapping the X glyph next to the Location name (UI Element 61). A user may close the Add Venue screen without selecting a venue by tapping the X glyph on the left side of the navigation bar (FIG. 38, UI Element 57).

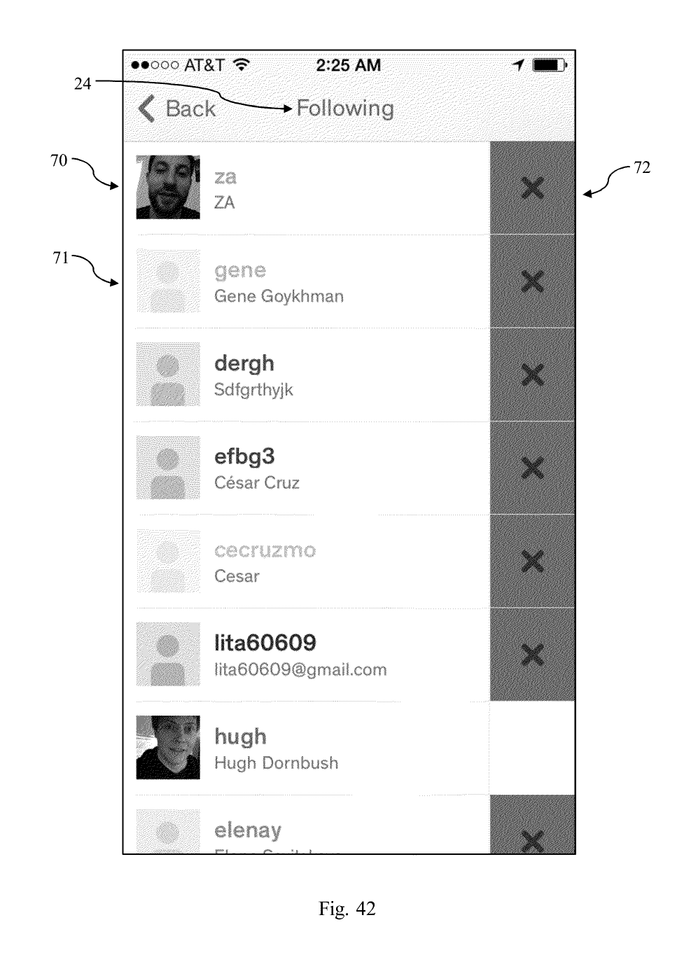

Upon tapping a location (either a city or venue name) on any Selfie Cover (FIG. 3, UI Element 4) a user navigates to that location's Profile (FIG. 40). Helper text on the navigation bar (UI Element 24) reads “Location”. Below the navigation bar, information about the location such as its name, address, and location metadata (if applicable) is displayed on an opaque field of the user's color, in this case blue (UI Element 63). A user may display a list of users following this Location (FIG. 42) by tapping “Followers” (FIG. 40, UI Element 62). A count of how many Selfies have been posted at this location is displayed to the right (UI Element 64). A Follow button (UI Element 65) allows a user to add Selfies tagged with this specific location to his or her feed of followed accounts. Below the Follow button is a scrollable results feed of all the Selfies associated with this location (UI Element 66).

Upon tapping a username on any Selfie Cover (FIG. 3, UI Element 4) or in any caption (FIG. 3, UI Element 9), a user navigates to the requested user's Profile (FIG. 41). Helper text on the navigation bar (UI Element 24) reads “Profile”. Below the navigation bar, information about the user such as his or her username, full name and bio is displayed on an opaque field of the user's color, in this case blue (UI Element 67). A user may display lists of users following this user and whom this user is following (FIG. 42) by tapping “Followers” or “Following” (FIG. 40, UI Element 62). A count of how many Selfies this user has posted is displayed to the right (UI Element 68). A Follow button (shown in the depressed “Following” state), UI Element 69, allows a user to add Selfies posted by this user to his or her feed of followed accounts. Below the Follow button is a scrollable results feed of all the Selfies posted by this user (UI Element 66).

If a user elects to load a list of followers, Selfie displays a list of results (FIG. 42). On the navigation bar helper text reads “Following” or “Followers” (UI Element 24). Below the navigation bar is displayed a list of results (UI Element 70). Each user listed is described by his or her most recent cover, username (displayed in a user's color) and full name. Upon clicking a list item a user navigates to that user's Profile (FIG. 41). If a user has not yet posted a Selfie, and as a result has no most-recent cover, a placeholder cover depicting a simple glyph of a human head and shoulders in the specified user's color is displayed instead (FIG. 42, UI Element 71). A user may follow or unfollow another user from this list of results by tapping the follow/unfollow button on the right end of each list result (UI Element 72).

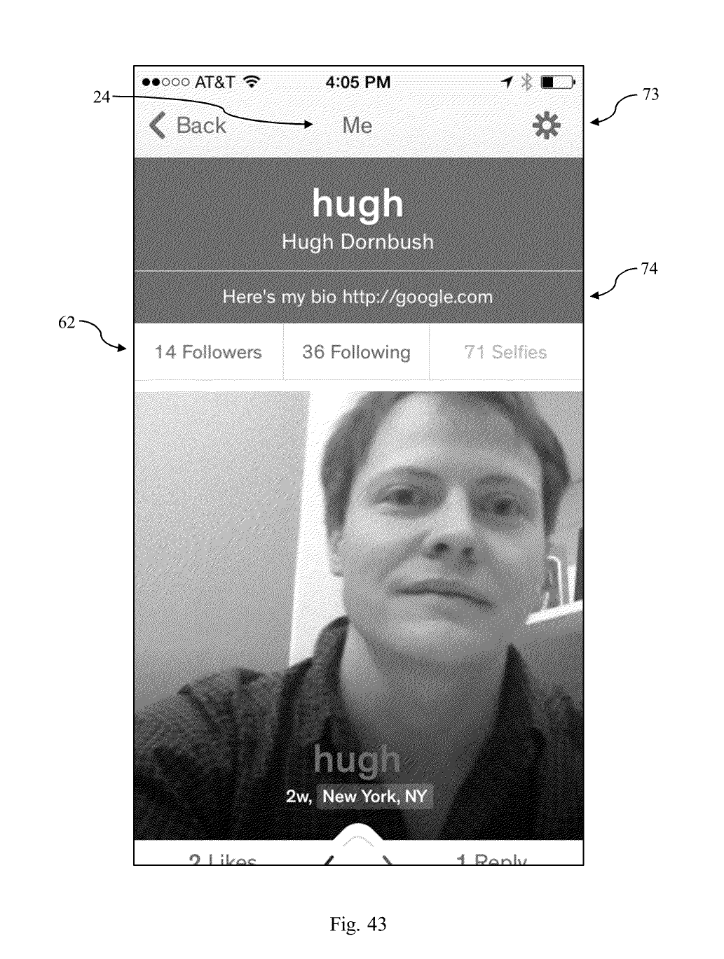

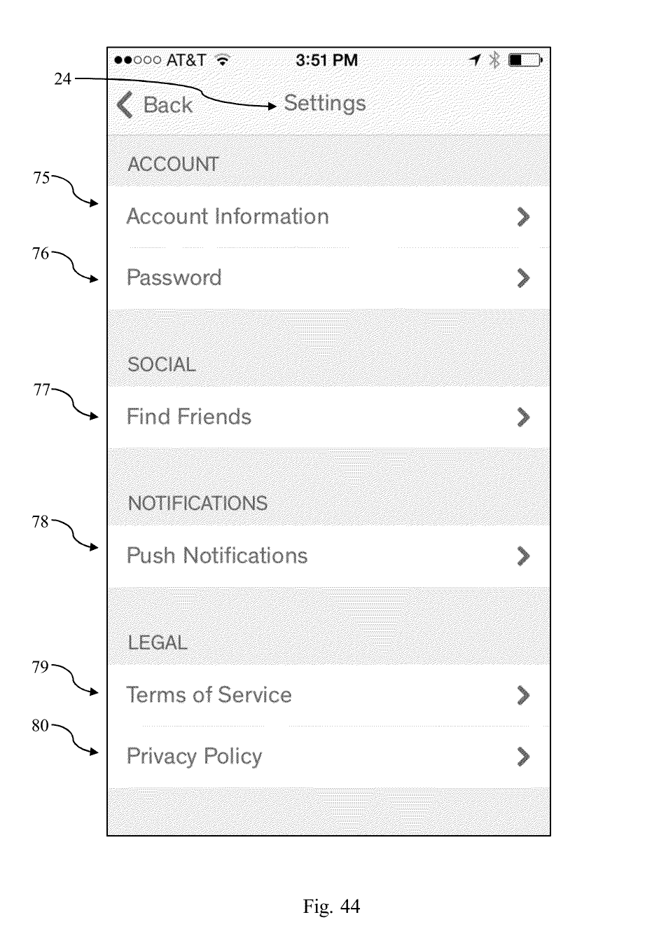

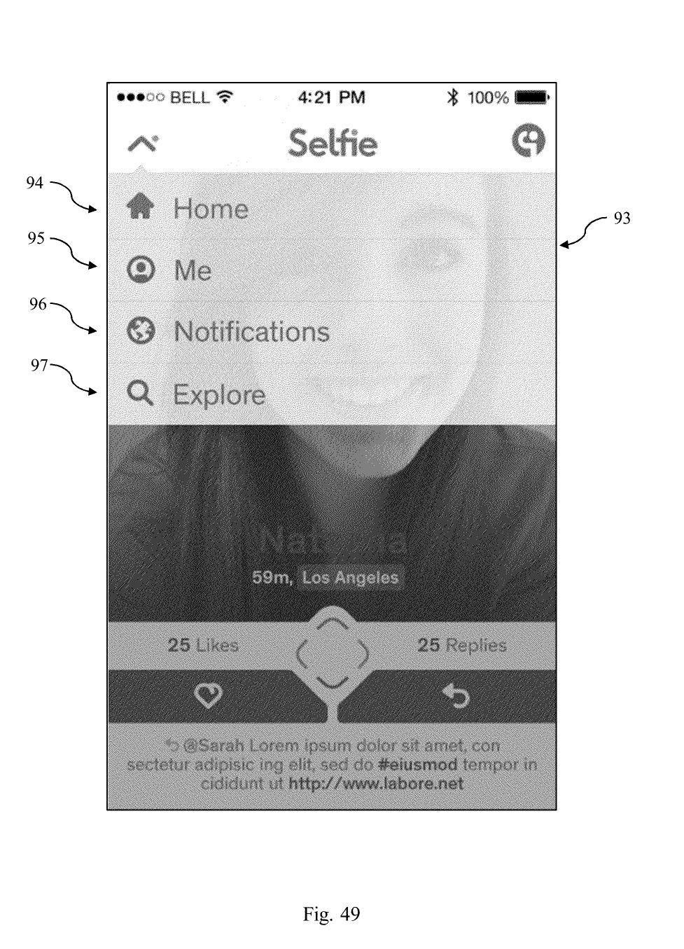

Upon tapping one's own username or “Me” from the Main Menu (FIG. 49, UI Element 95) a user navigates to his or her own Profile (FIG. 43). Helper text on the navigation bar (UI Element 24) reads “Me”. Below the navigation bar, information about the user such as his or her username and full name is displayed on an opaque field of the user's color, in this case green. A user may add or edit a short text bio by tapping his or bio (UI Element 74). A user may display lists of followers and people they are following (FIG. 42) by tapping “Followers” or “Following” (FIG. 43, UI Element 62), which also displays an item count, since a user is viewing his or her own profile. Below is a scrollable results feed of all the Selfies posted by this user (FIG. 41, UI Element 66). The user may tap a Gear glyph on the right side of the navigation bar (UI Element 73) to access his or her Settings (FIG. 44).

A user taps the Gear icon on his or her own profile to access Settings (FIG. 44) where a user may configure several aspects of his or her Selfie experience. Helper text on the navigation bar communicates that the user is on the “Settings” screen. (FIG. 44, UI Element 24) From this screen, tapping on any Settings item will navigate to an additional window where a user may take additional action. These Settings items include: accessing Account Information (UI Element 75), changing the user Password (UI Element 76), Find/Add Friends (UI Element 77), Push Notifications (UI Element 78), Terms of Service (UI Element 79) and Privacy Policy (UI Element 80).

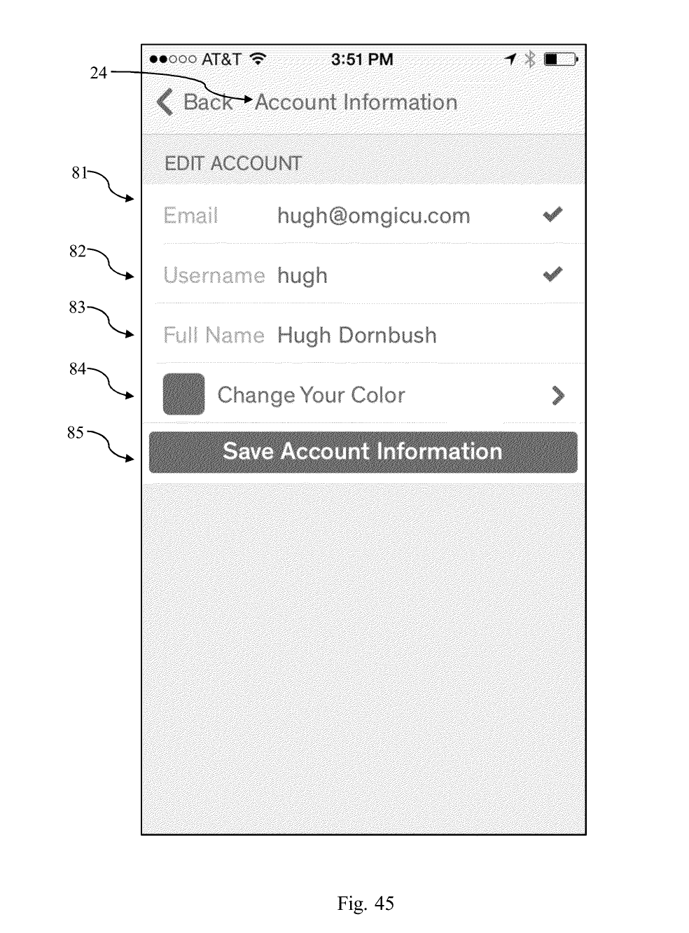

When a user taps Account Information (FIG. 44, UI Element 75) he or she navigates to the Account Information screen (FIG. 45). On the resulting screen, helper text on the navigation bar communicates that the user is on the “Account Information” screen. (FIG. 45, UI Element 24). A user may edit various aspects of his or her Selfie account, including: email address (UI Element 81), username (UI Element 82), full name (UI Element 83) and color (UI Element 84). When a user has finished editing his or her account settings, tapping “Save Account Information” (UI Element 85) saves all information.

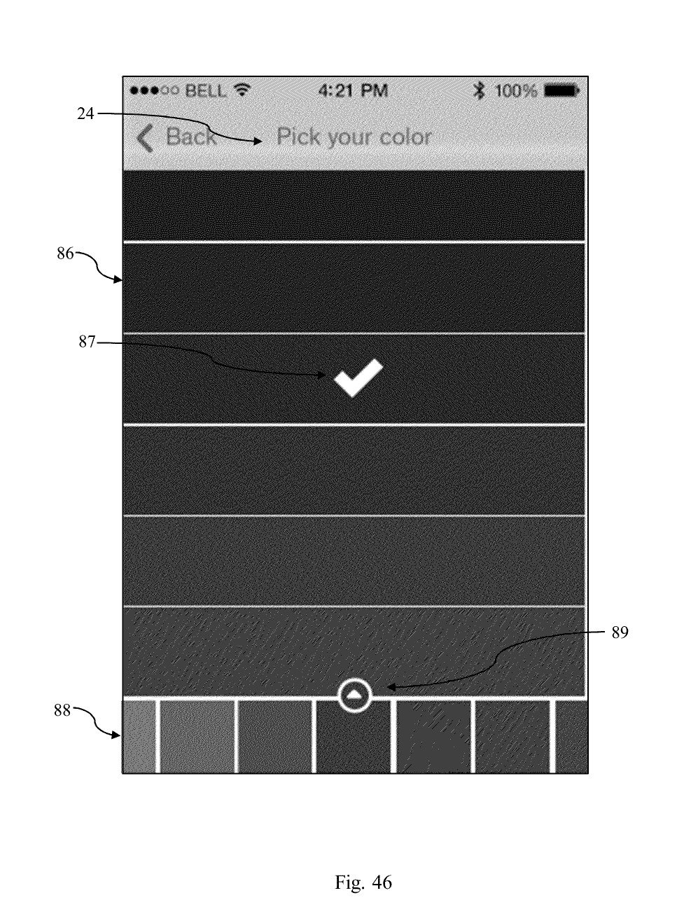

When a user taps “Change Your Color” (FIG. 45, UI Element 84) he or she navigates to the Color Picker (FIG. 46). Helper text on the navigation bar communicates that the user may “Pick Your Color” (FIG. 46, UI Element 24). A horizontal band of Basic Color blocks is displayed along the bottom of the screen (UI Element 88), wherein a horizontal movement causes the horizontal band to display a different set of Basic Color blocks. A user specifies one of these Basic Color blocks by centering it under UI Element 89, a colored circle displaying a triangle pointing upwards towards a vertically-scrollable feed (UI Element 86) of detailed shades of the currently-selected Basic Color block. By scrolling up and down through the detailed shades, a user may find and select the nuanced shade of the Basic Color block he or she is seeking. When a user has found their desired color, he or she taps the desired color, selecting the color and displaying a white checkmark (UI Element 87) to communicate the recently selected color.

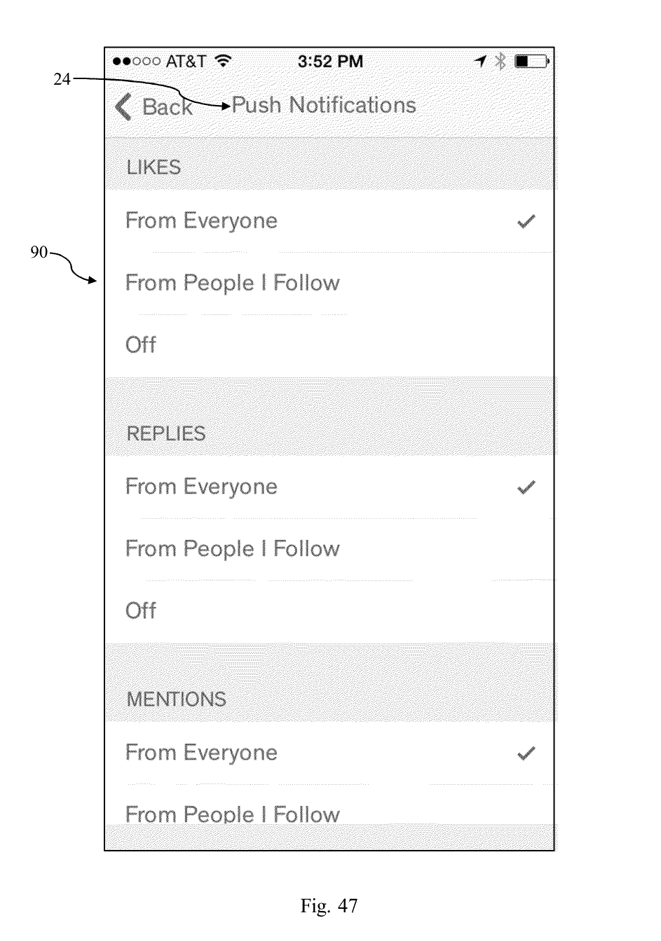

When a user taps Push Notifications (FIG. 44, UI Element 78) he or she navigates to the Push Notifications screen (FIG. 47). On the resulting screen, helper text on the navigation bar communicates that the user is on the “Push Notifications” screen. (FIG. 47, UI Element 24). A user may designate whether they would like to receive push notifications about activity on Selfie from everyone, from only people he or she follows, or from no one (UI Element 90).

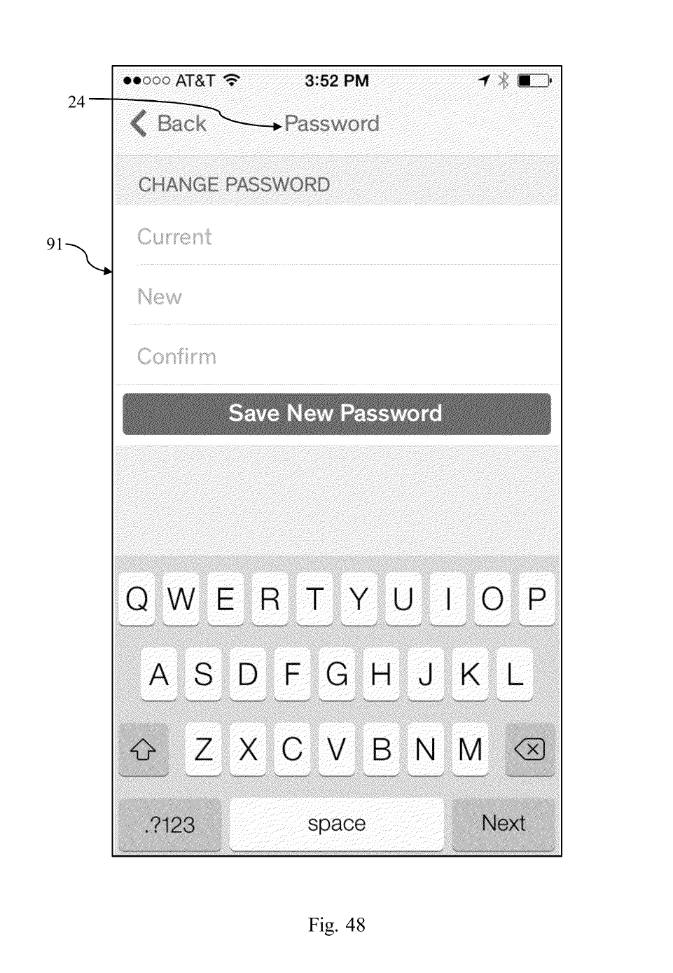

When a user taps Password (FIG. 44, UI Element 76) he or she navigates to the Password screen (FIG. 48). On the resulting screen, helper text on the navigation bar communicates that the user is on the “Password” screen. (FIG. 48, UI Element 24). A user may change his or her password here. (UI Element 91).

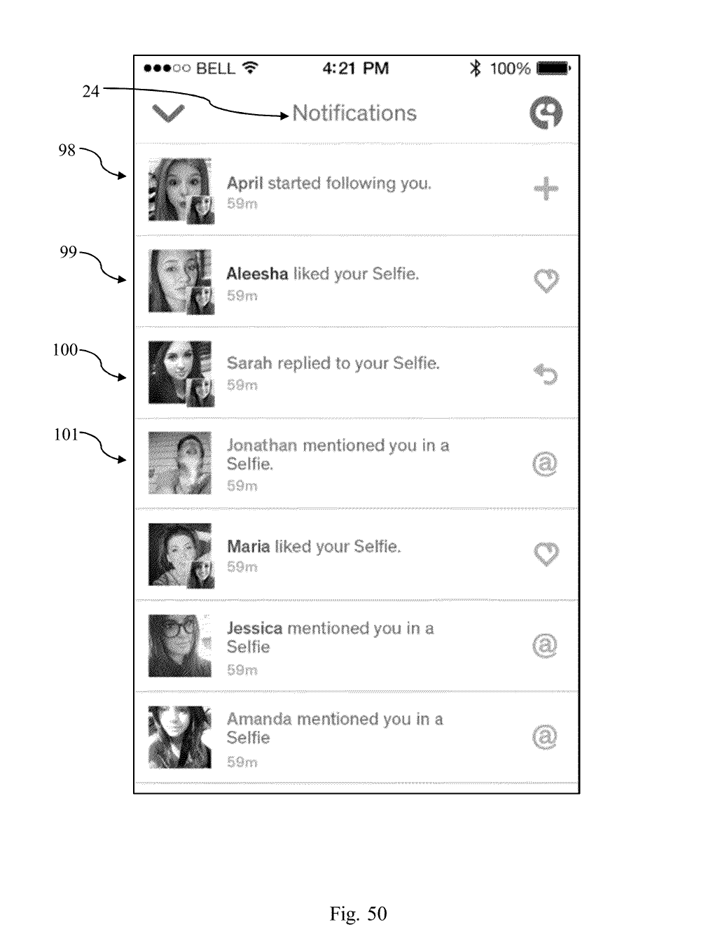

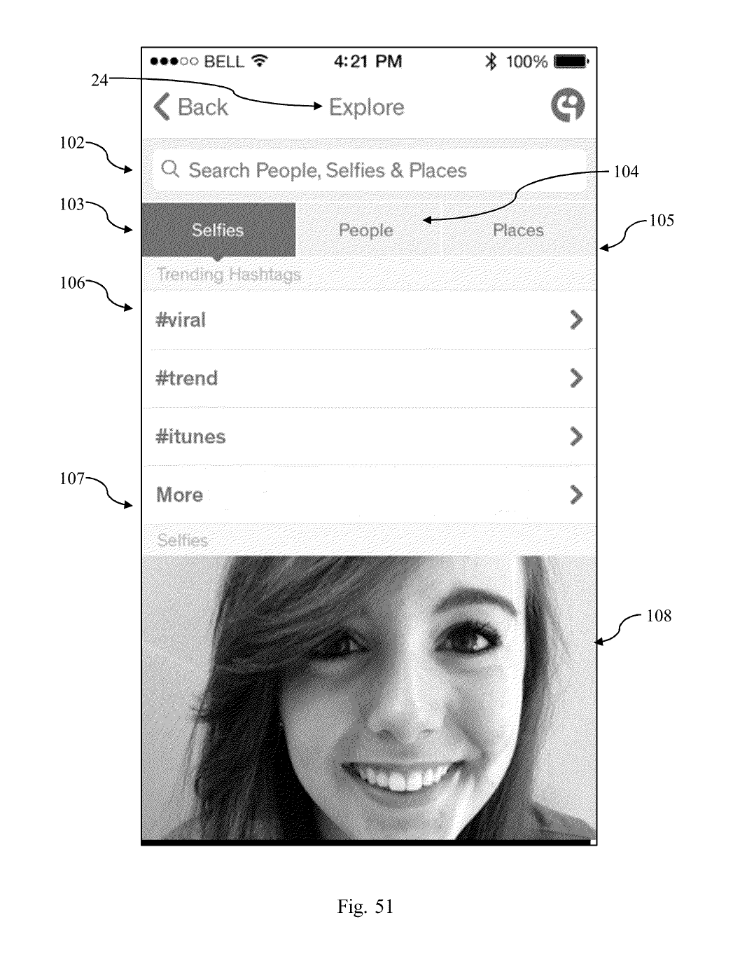

On the left end of the navigation bar is a downward facing chevron glyph serving as the Main Menu button (FIG. 3, UI Element 1). Upon tapping this button, a semi-transparent menu (FIG. 49, UI Element 93) descends from the navigation bar to present the user with menu options including Home (UI Element 94), Me (UI Element 95), Notifications (UI Element 96) and Explore (UI Element 97). Tapping the Menu button or any area below the menu will close the Main Menu by scrolling up. Tapping “Me” will navigate the user to his or her own profile (FIG. 43). Tapping “Notifications” will navigate the user to his or her notifications screen (FIG. 50). Tapping “Explore” navigates the user to an Explore area (FIG. 51).

Upon tapping “Notifications” in the Main Menu a user navigates to his or her “Notifications” screen where he or she can view a list of happenings on Selfie that relate to him or her (FIG. 50). Here, a time-ordered list displays events such as when another user started following you (UI Element 98), when another user started liked your Selfie (UI Element 99), when another user replied to your Selfie (UI Element 100) or when another user mentioned you in a Selfie (UI Element 101).

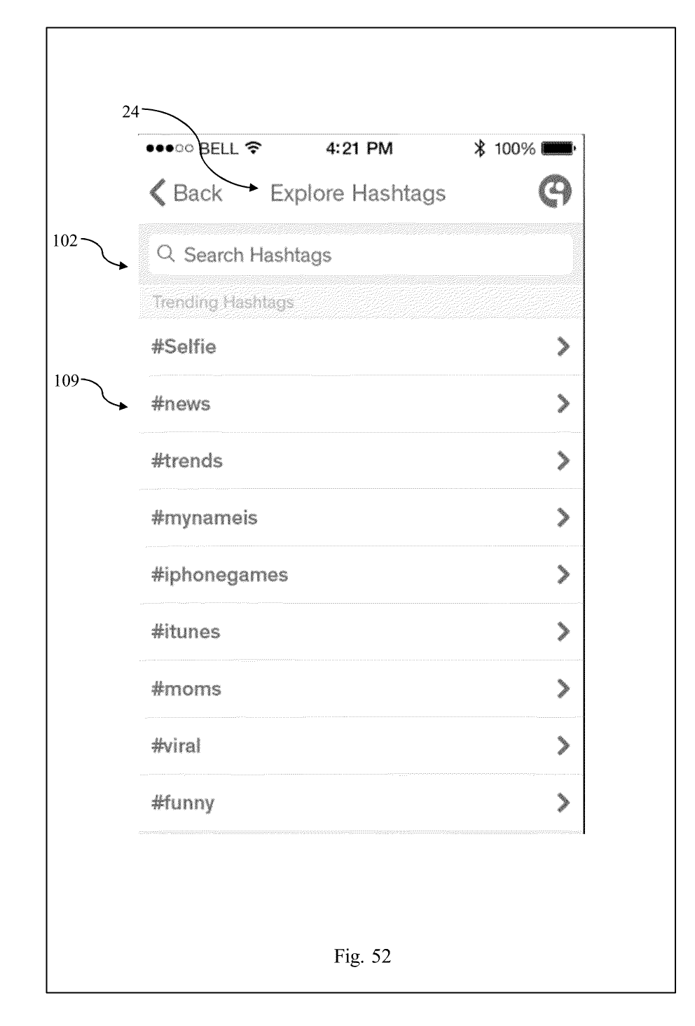

Upon tapping “Explore” in the Main Menu a user navigates to an Explore area (FIG. 51) where he or she can explore, view and search for Selfies, people, places and hashtags (FIG. 51) Helper text on the navigation bar communicates that the user is in the “Explore” area. (FIG. 51, UI Element 24). Below the navigation bar is a search box a user can tap to initiate a search for “People, Selfies and Places” (UI Element 102). Below the search box are three selectable tabs that the user may toggle between: Selfies (UI Element 103), People (UI Element 104), and Places (UI Element 105). “Selfies” is selected by default. Below the three tabs is a short list of three trending hashtags (UI Element 106) followed by an option to see “More” hashtags (UI Element 107). Tapping any of the hashtags navigates to a hashtag results screen (FIG. 53) while clicking “More” navigates to the “Explore Hashtags” screen (FIG. 52). Below the hashtags area in FIG. 51 is a results feed of editorially-selected and curated Selfies for users to explore (UI Element 108).

Upon loading the Explore Hashtags screen (FIG. 52) helper text on the navigation bar communicates that the user is in the “Explore Hashtags” area. (FIG. 52, UI Element 24). Below the navigation bar is a search box a user can tap to initiate a search for hashtags (UI Element 102). Below the search box is a complete list of trending hashtags (UI Element 109). Tapping any of the hashtags navigates to a hashtag results screen (FIG. 53).

Tapping a hashtag, either in the explore area (FIG. 51) or in the text caption of any Selfie (FIG. 3, UI Element 9) effectuates a search for the specified hashtag and navigates a feed of results. (FIG. 53). Helper text on the navigation bar communicates the hashtag search performed. (FIG. 53, UI Element 24). Below the navigation bar is a vertically scrollable feed of results. (UI Element 66).

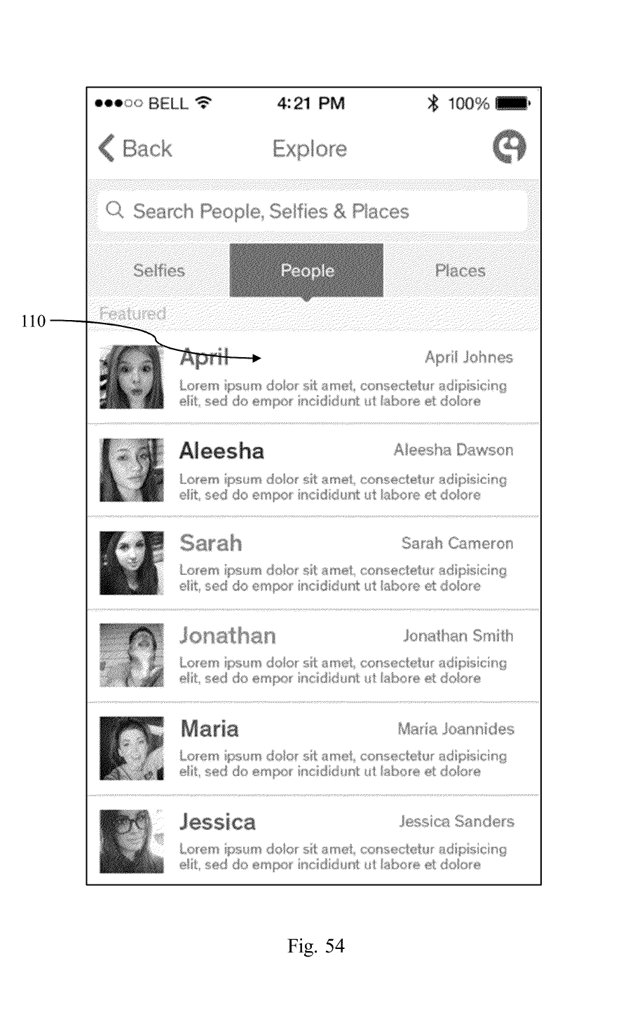

Tapping “People” in the Explore area (FIG. 51, UI Element 104) changes the displayed results to reflect Selfie users, not their content (FIG. 54). By default, a list of Featured People is displayed (UI Element 110) with each user described by his or her most recent cover, username, full name and bio. Once a user begins to search for People, this list of featured users is replaced by a list of search results, updated dynamically as the user enters each character.

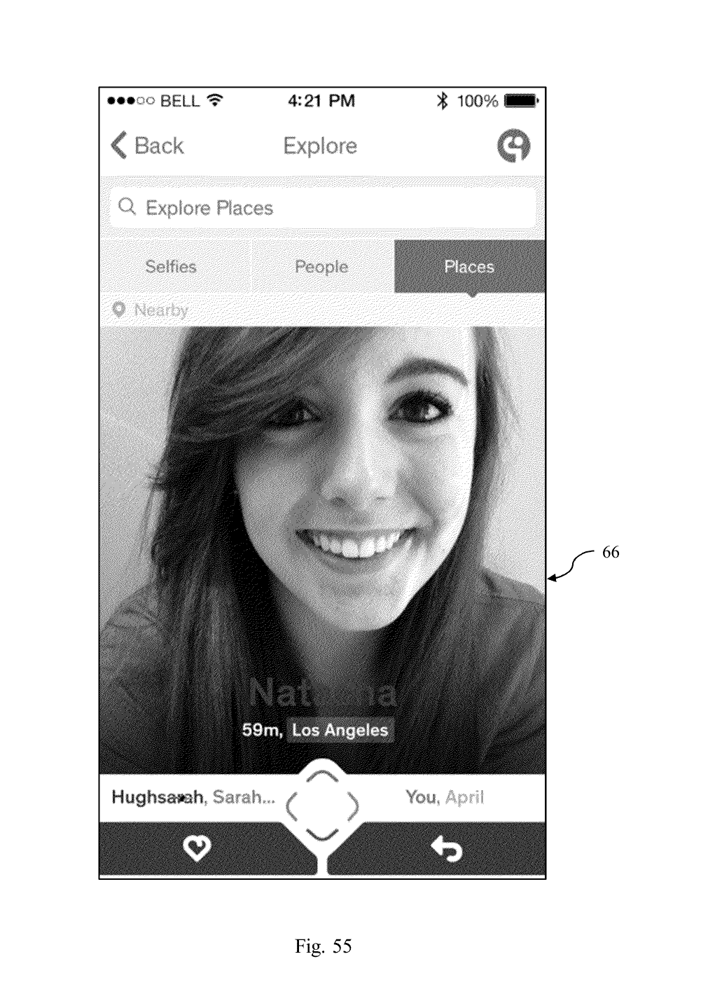

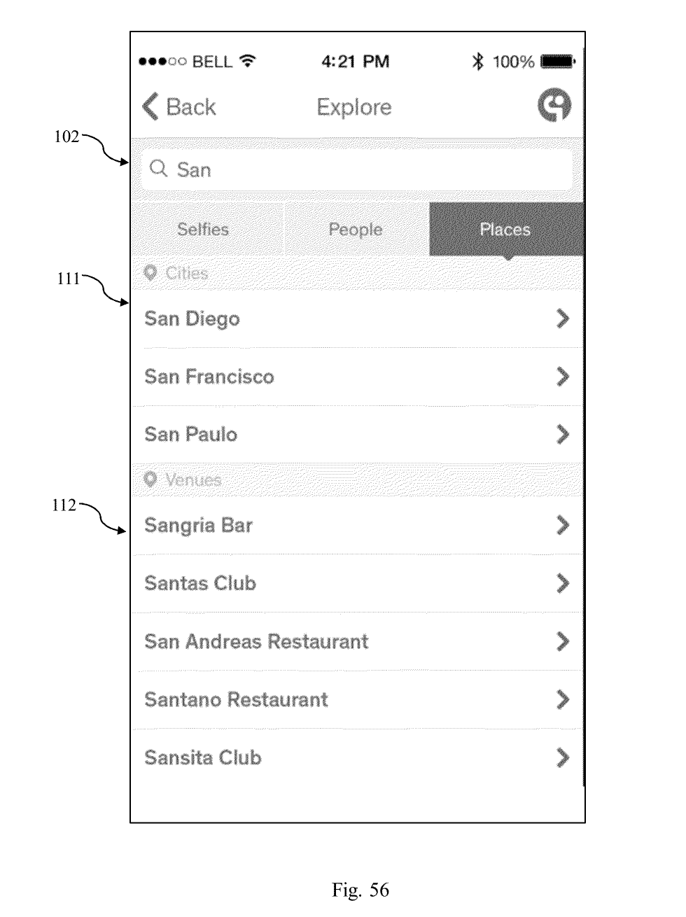

Tapping “Places” in the Explore area (FIG. 51, UI Element 105) changes the displayed results to reflect locations (FIG. 55). By default, a feed of nearby Selfies is displayed (UI Element 66). When a user clicks the search box, Selfie allows the user to Search (FIG. 56).

As a user searches for a specific location (UI Element 102), results are updated as the user enters every character (FIG. 56). Search results are divided into results for Cities (UI Element 111) and Venues (UI Element 112).

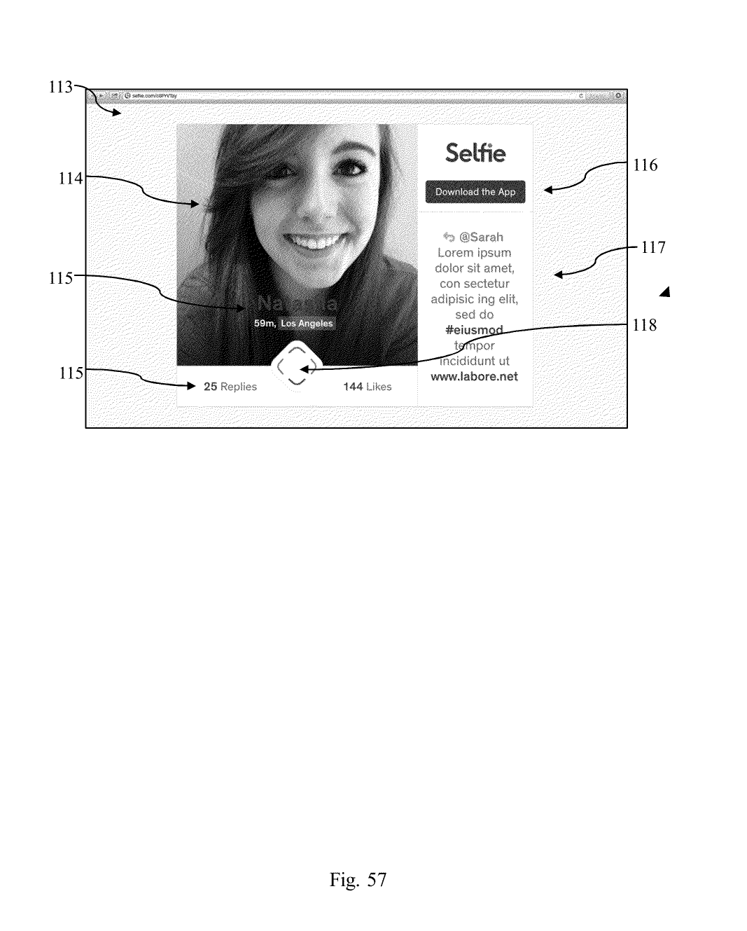

A Selfie may be shared to the web and opened on a computer's web browser (FIG. 57). A user's web browser via a URL (UI Element 113) is the standard method of browsing a Selfie on the web. When interacting with a Selfie on the web, a user may tap the Selfie (UI Element 114) to initiate playback. Metadata about the Selfie, which is provided in the form of the posting user's username, time since posting, location of post, count of Likes and count of Replies, are displayed in the same locations as Selfie for iPhone (UI Element 115). A user's caption is displayed to the right of a Selfie on the web (UI Element 117). A Selfie has a Conversation button (UI Element 118). By opening a Conversation or using slide navigation on the web, a user may navigate to browse any Selfie within the current Conversation but cannot navigate to another conversation. A web user may click UI Element 116, a “Download the App” button in the color of the posting user, to download Selfie from an app store and become a Selfie user him or herself.

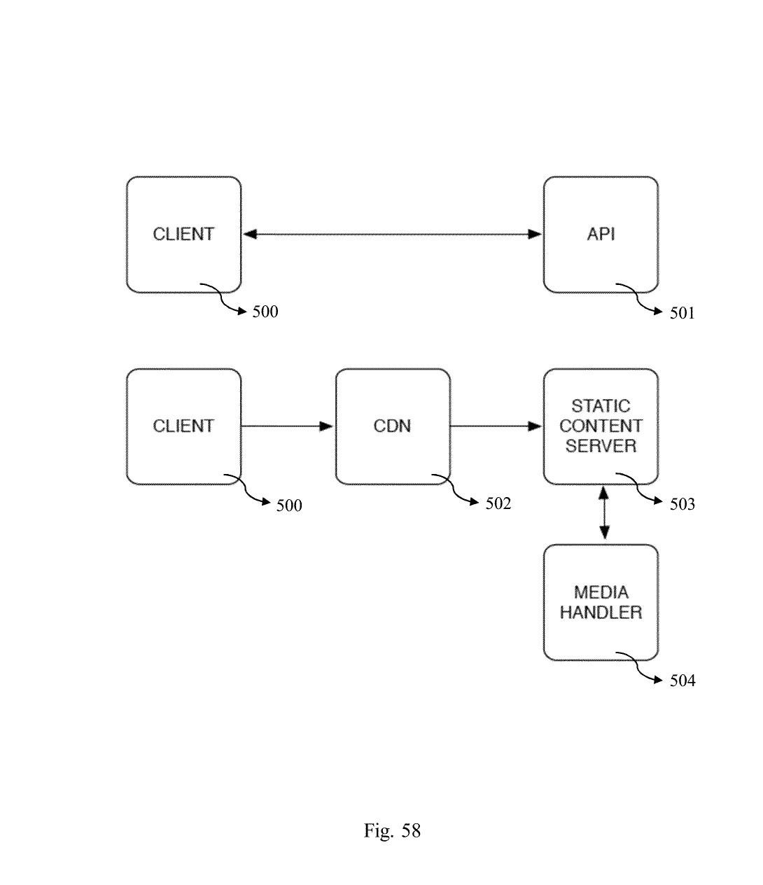

FIG. 58 shows a process for media discovery and loading in order to properly display Selfies. The client 500 first requests details about a Selfie that they would like to display from the API 501. As part of the response the client receives details about the location of the various media required to display the requested Selfie. In certain cases, the client may also infer the location of the media it wants to request using other metadata or properties that it has received such as the unique ID for an individual Selfie post. The client then makes a request to an address that represents one of a number of caching servers 502 that the client may access depending on the proximity of the caching server and the client's network conditions. This caching server will respond with the requested media file if it has the file saved; otherwise it will pass the request along to a Static Content Server 503. This Static Content Server will respond with the applicable media files; however if it doesn't have media in an appropriate format, it will request the appropriate format from the Media Handler 504 which will then generate it and cache it on the static content server for later requests. In one embodiment the Static Content Server sends the data to the client. In an alternative embodiment, the Static Content Server merely sends a request for format conversion to the Media Handler, which adapts the data from its original form and returns the requested format to the Static Content Server which returns it back to the requesting client.

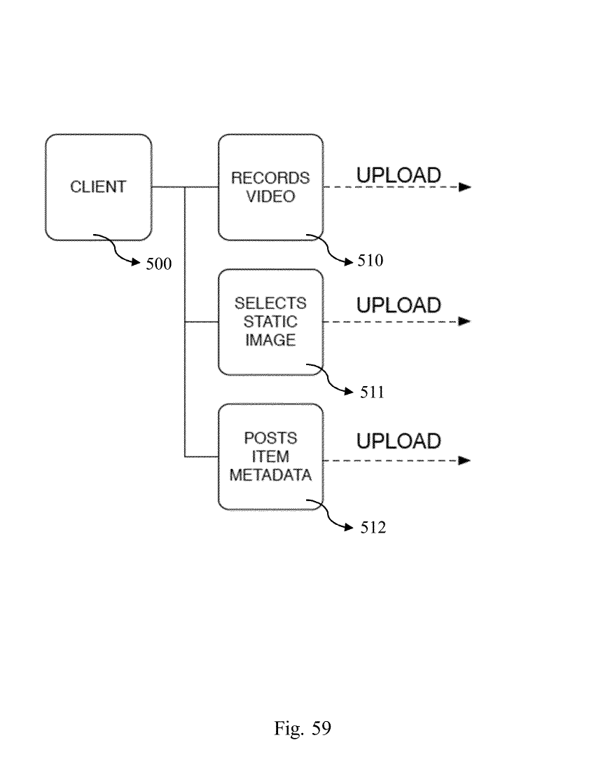

FIG. 59 outlines a process for uploading a new Selfie to the API from the perspective of the client 500. The client may start uploading a video stream 510 or file as soon as the recording process starts. After completing recording, the client selects and processes a static image 511 from a video frame to represent the video that they recorded. This static image is then uploaded. Alternatively, the client could pass a time stamp for the static image to the server. However, uploading the image itself allows for better quality. Finally, the client provides details about the video such as location, a caption, people involved, venue information, recording time, an access control list for the video, et cetera. These details, i.e., “metadata,” are sent 512 upon the completion of video and static image uploads to “finalize” and publish the post. At this point, the video becomes accessible to others on the Selfie network, consistent with the access controls.

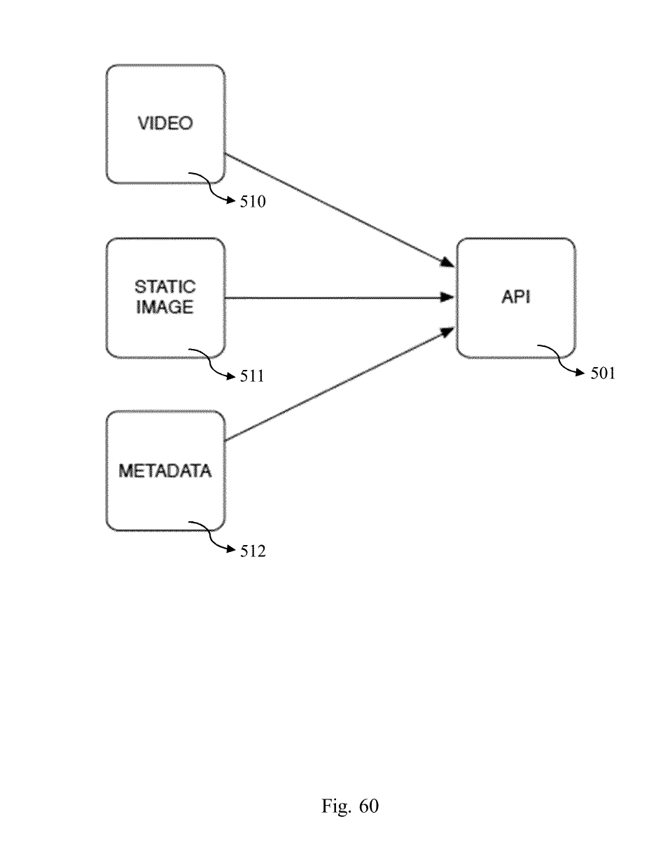

FIG. 60 outlines a process for receiving a complete Selfie from the perspective of the API 501. Videos 510 and static images 511 are received by the API 501 and are first tested for validity. Several checks are performed including validating binary format as well as container validity and metadata consistency to ensure that the API is not receiving corrupted or malicious data. The length of the video is also determined as the system constrains the video length to a maximum time. Once all media files and metadata have been received, the media elements are “posted” by being sent to the correct location on their appropriate media handler or content server.

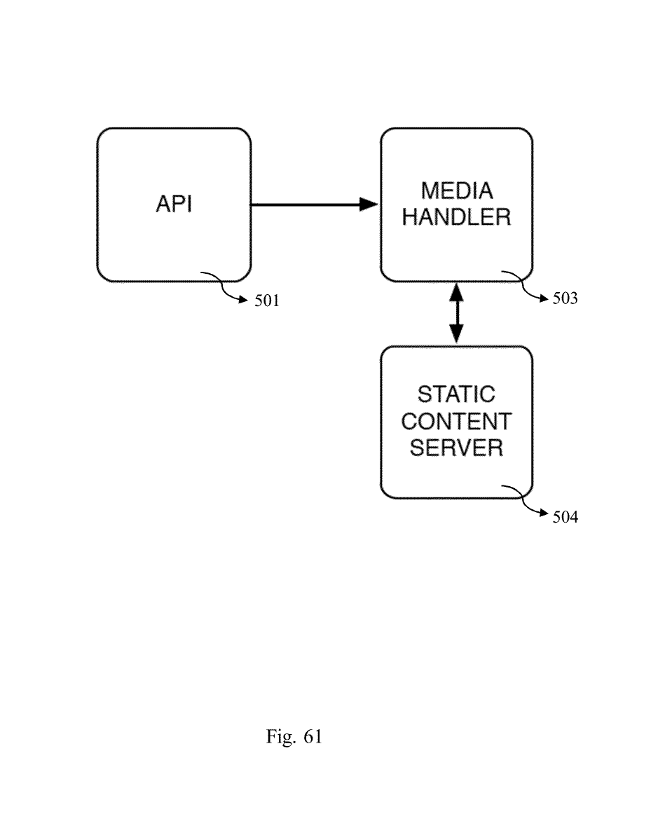

FIG. 61 shows how content is handled upon successful receipt of the API 501. Once the received media has been finalized and verified, it is sent along its way to the most appropriate media handler 503. The API passes along a checksum of the files as they are sent to the handler which the handler than validates to ensure that the files are transmitted without corruption. The files are placed in an appropriate location in the Static content server 504 depending on their privacy level and protections required as well as the expected geographic location of its viewers.

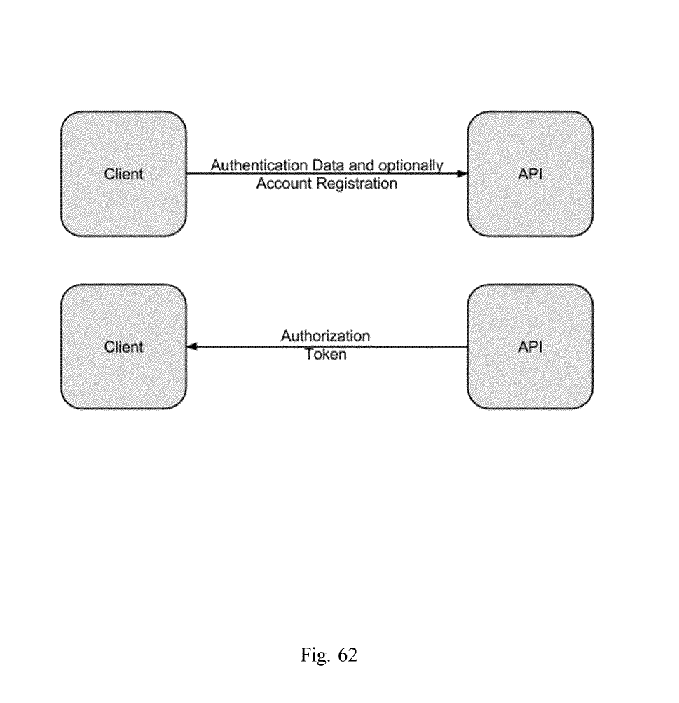

FIG. 62 shows the procedure for user registration and authentication. The process involves the client sending authentication data, and optionally, data to allow for new user registration. In response the registration/authentication API resident in the services server will transmit an authorization token to the client. The authorization token allows further use of the system service via the API and other backend services.

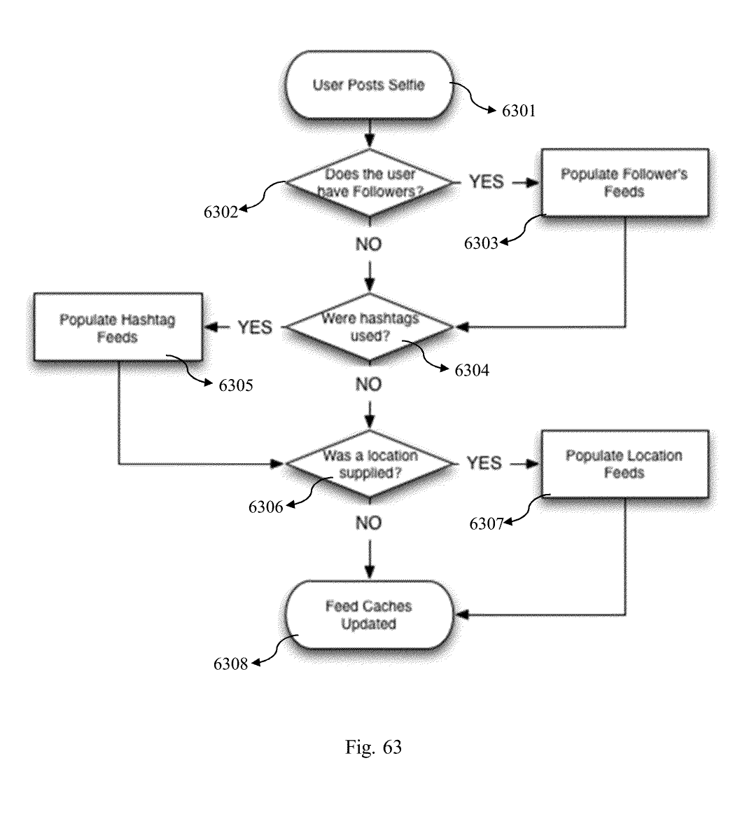

FIG. 63 describes an exemplary process for feed generation upon creation of a new post. As stated above, a user queries feeds as a primary avenue for consuming content. As such, this diagram expands upon how data is generated that the service would return in FIGS. 58 and 60 when browsing such a feed. When a new post is submitted 6301, the author's follower list is queried 6302 to determine if the user has followers. If the user submitting the new post has followers, criteria are applied (e.g. if the post is a reply or not and if the follower in question follows the user the post is a reply to) to determine if the post should be inserted into each follower's feed cache 6303. Subsequently, a determination is made whether hashtags were used 6304. If so, the post may be inserted into feed caches for the individual hashtags used 6305. Next, the post is searched for location or venue information 6306. If so the post is inserted into a feed for the specific location or venue in question 6307. Finally, the caches for the feeds are updated 6308.

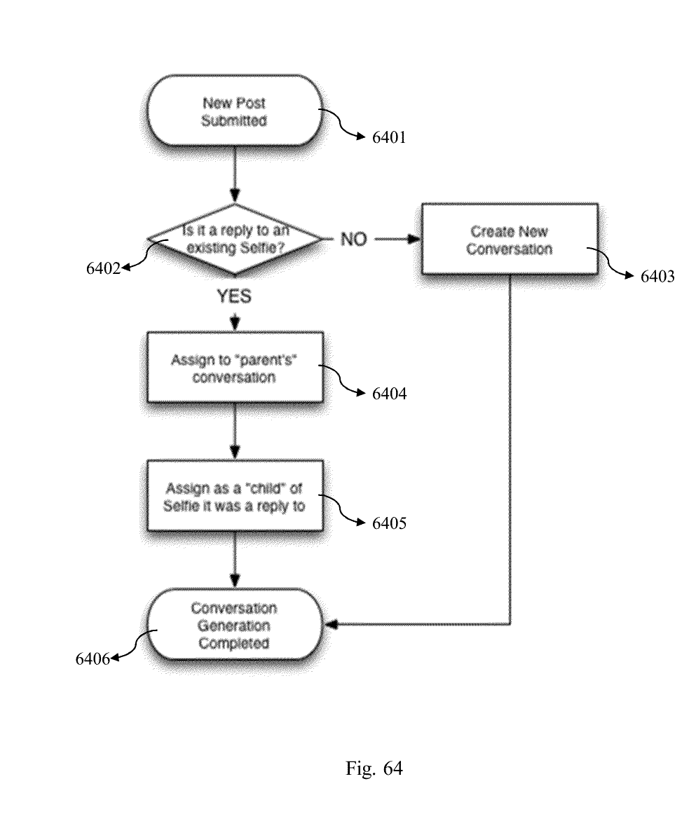

FIG. 64 discloses an exemplary process for conversation generation. In the context of a conversation, this figure describes how data is generated that would be returned to the client in FIGS. 58 and 60. This data is required to support Conversation View and Slide Navigation. The process begins with a newly posted Selfie 6401. Next, a determination is made whether the Selfie in question is a reply 6402. If the Selfie is not a reply, it is denoted as a new Conversation or new collection of inter-related Selfies 6403. If the Selfie is a reply to an existing Selfie, it is assigned to the Conversation its “parent” 6404 that the Selfie it is a reply to. In particular, a further determination is made to decide where the Selfie fits in the overall conversation 6405, by assigning the Selfie as a “child” of the Selfie to which it is responding. Next, the corresponding conversations are updated or generated to include the new Selfie 6406.

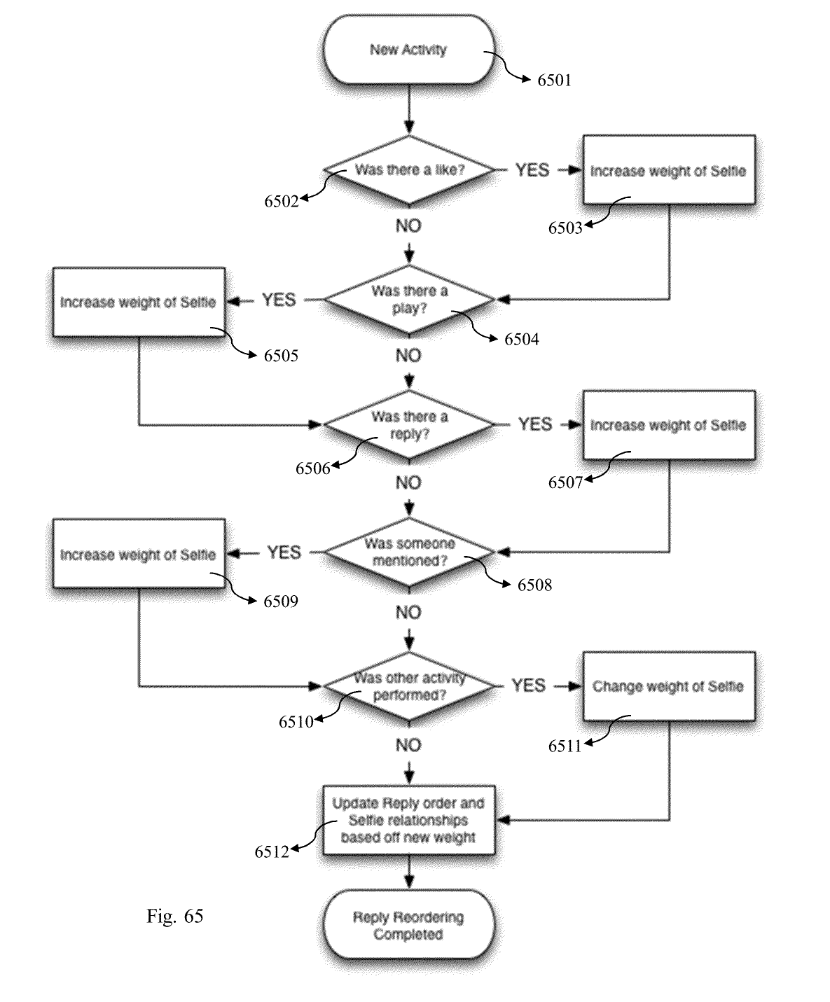

FIG. 65 discloses an exemplary embodiment of a reply ordering algorithm. This provides how replies to a specific Selfie are ordered in the vertical list when a Selfie has more than one reply. The basic idea is to include “weight” metadata to each Selfie based on various characteristics. The “weight” is a numerical value assigned to any given Selfie. This data would be returned from the API to the client as described in FIGS. 58 and 60 and is essential for supporting Conversation View and Slide Navigation. This “weight” is used to order the collection of replies to a single Selfie, thereby determining the importance or prominence of an individual reply amongst its peers or “siblings.” Various methods and algorithms to determine this weight may be used and they are evolved over time. Upon a new like, the weight may be increased by some value. Upon a new view or play of a Selfie, the weight may be increased by some value. If the Selfie receives a reply, the weight may increase by some value. If a user was mentioned in a Selfie, their reply to that Selfie's weight may be increased by some value. If a user behavior or action as determined by our customizable algorithm occurs, the weight of that user's reply may be increased or decreased. After these criteria are traversed, the new order of replies is set and cached, and inter-relationships between the “next” and “previous” Selfies in the list are also set and cached.

The process begins when a new activity occurs 6501, which can be any event in the system such as a like. Next, a determination is made if the event was a “like” 6502. If so, the weight is increased 6503. Next, a determination is made if the “event” was a play 6504. If so, the weight is increased 6505. Next, a determination is made if there was a reply 6506. If so, weight is increased 6507. Next, a determination is made whether someone was mentioned 6508. If so, the weight is increased 6509. Next, other possible activities can be checked 6510. And based on the activities other weights can be added or subtracted 6511. After the weighting process is performed the order of the replies can be reset to reflect the current weight values of all replies. Note, the weights added for each event can be the same for each type of event, e.g., plus 1. Or, the system operator can advantageously provide more weight for certain kinds of events that the operator believes are more relevant. For example, the operator might believe that prompting a reply should be given far more weight than a mere like.

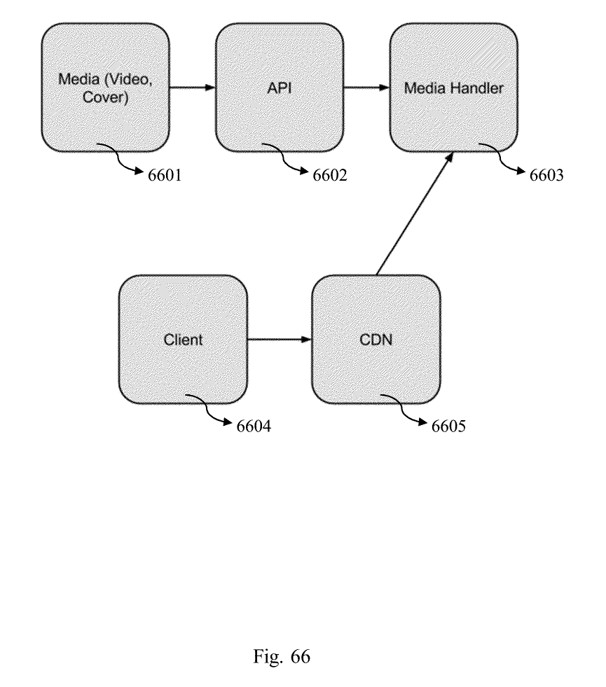

FIG. 66 is an exemplary embodiment of how media traverses the server backend. Incoming, content uploaded by end users is shown at box Media (Video, Cover) 6601. That incoming media is then accepted by the main server interface API 6602. From there the media is pushed out to a feature-oriented micro-service called the “Media Handler” 6603. The Media Handler also accepts requests from clients for outgoing content to be served 6504. Those requests are proxied through a CDN 6505 for both videos as well as processed graphical elements. An example of a processed graphical element would be an image representing a Selfie with a “play” button overlaid upon it for use on various social media platforms to infer that the content being shared is a video.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teaching the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A computer-implemented method for presenting and interacting with a computing device having a screen to provide an asynchronous video conversation chain comprising:
displaying a first video on the screen of the computer device, wherein the video comprises a portion of a conversation in reply to an earlier video, and wherein the computer device is configured to accept user input;
receiving user input representing a directional movement vertically or horizontally;
displaying a second video in the conversation that is a reply to the first video when the accepted user input is a horizontal directional movement in a first direction;
displaying the earlier video when the accepted user input is a horizontal directional movement in a second direction; and
displaying a third video that is a reply to the earlier video when the accepted user input is a vertical directional movement.

2. The method of claim 1 wherein the user input is provided via a touch interface.

3. The method of claim 2 wherein the first direction is left.

4. The method of claim 1 wherein the user input includes a four way directional input graphical interface element.

5. The method of claim 4 wherein the first direction is right.

6. The method of claim 1 wherein two or more videos are arranged vertically around the first video and are accessed via the vertical directional movement and wherein the order of the two or more videos is determined based on a weight computed using one or more of the following criteria: likes, plays, replies, or mentions.

7. The method of claim 1 further comprising displaying a user interface element to initiate a reply to the first video.

8. The method of claim 1 further comprising displaying a user interface element to initiate a like of the first video.

9. The method of claim 2 wherein the horizontal directional movement and the vertical directional movement are accomplished with a swipe gesture.

10. A computer-implemented method for presenting a user interface for video recording on a device comprising a display screen and a front facing camera providing a video feed to the device and a user input apparatus, the method comprising:
displaying a live view of the video feed from the front facing camera on the display screen;
receiving via a record command via the user input apparatus;
initiating recording in response to the record command; and
obscuring the display of the live view of the video feed from the front facing camera in response to the record command and continuing to obscure the display while recording is ongoing.

11. The method of claim 10 further comprising providing a user interface element to toggle the obscuring feature on and off.

12. The method of claim 10 further comprising displaying a message on the display screen directing a user to look at the camera in response to the record command.

13. The method of claim 10 wherein the obscuring is accomplished by blurring the live view of the video feed.

14. The method of claim 10 wherein the obscuring is accomplished by turning off the screen.

15. The method of claim 10 wherein the obscuring is accomplished by replacing the video screen with a graphic.

16. A system for presenting and interacting an asynchronous video conversation chain comprising:
a computing device having a touch screen, a processor and a memory;
computer code stored in the memory and configured to:
display a first video on the screen of the computer device, wherein the video comprises a portion of a conversation in reply to an earlier video, and wherein the computer device is configured to accept user input;
receive user input via the touch screen representing a directional movement vertically or horizontally;
display a second video in the conversation that is a reply to the first video when the accepted user input is a horizontal directional movement in a first direction;
display the earlier video when the accepted user input is a horizontal directional movement in a second direction; and
display a third video that is a reply to the earlier video when the accepted user input is a vertical directional movement.

17. A computer-implemented method for presenting and interacting with a computing device having a touch screen to provide an interface for selecting a color, comprising:
displaying a first set of color blocks arranged in a horizontal band across the screen of the computing device;
receiving user input via the touch screen representing a horizontal directional movement, and in response displaying a second set of color blocks in the horizontal band across the screen of the computing device;
receiving user input via the touch screen representing a tap on the desired color block, and in response displaying a first set of detailed shades of the selected color in vertical bands on the screen of the computing device;
receiving user input representing a vertical directional movement along the bands of detailed shades of the selected color, and in response displaying a second set of detailed shades of the selected color in vertical bands on the screen of the computing device, wherein the second set of detailed shades of the selected basic color comprises a lighter or darker set of shades contiguous to the first set of shades; and
receiving user input via the touch screen representing a tap on the desired shade of the selected color.

18. The method of claim 17 wherein the first set of colors comprises a portion of all available colors and wherein the second set of colors comprises a different portion of all available colors.

19. The method of claim 17 wherein the first set of detailed shades comprises a portion of all possible shades of a given color and wherein the second set of detailed shades comprises a different portion of all possible shades of the said given color.

20. A computer-implemented method using a computer server system for uploading a video as part of an asynchronous video conversation chain, comprising:
receiving video stream data from a client computing device immediately after said client computing device begins recording a video;
receiving and processing a static image from a frame of the recorded video once the full video stream data has been received;
receiving metadata associated with the recorded video, wherein said metadata includes one or more of the following: the location where the video was recorded, a caption describing the video, people involved in the video, venue information, recording time, and access controls; and
making the video available for display to other users by linking the associated metadata and the processed static image to the received video stream.

21. The method of claim 20 wherein the receiving of the static image is accomplished by receiving a time stamp identifying the location of the static image in the video stream.

22. The method of claim 20 wherein the computer server limits access to the recorded video according to the access controls as received in the associated metadata.
